(19) United States
(12) Patent Application Publication
(10) Pub. No.: US 2024/0349774 A1
(43) Pub. Date: Oct. 24, 2024

(54) INFUSION APPARATUS

(71) Applicant: Todd Shermer, Irvine, CA (US)

(72) Inventor: Todd Shermer, Irvine, CA (US)

(21) Appl. No.: 18/642,344

(22) Filed: Apr. 22, 2024

Related U.S. Application Data
(60) Provisional application No. 63/497,272, filed on Apr. 20, 2023.

(51) Int. Cl. A24B 3/12; A01G 7/06; A24B 15/30

(52) U.S. Cl. CPC A24B 3/12; A24B 15/30; A01G 7/06

(57) ABSTRACT

A infusion apparatus configured to infuse reagents into plant matter, the infusion apparatus having: a reagent dispenser having at least one reagent: a vaporizer in fluid communication with the reagent dispenser; a vacuum chamber in fluid communication with the vaporizer; a vacuum pump in fluid communication with the vacuum chamber, and an infuser controller in electrical communication with the reagent dispenser, vaporizer, the vacuum chamber and the vacuum pump; wherein flow of each reagent from the reagent dispenser through the vaporizer and into the vacuum chamber is controlled by the infuser controller. The infusion apparatus may be configured to provide a scalable apparatus for infusion of large quantities of samples, such that sample throughput may be adjusted in accordance with the desired products.

### CROSS-REFERENCE TO RELATED APPLICATIONS

This application claims priority to U.S. Provisional Application No. 63/497,272, filed Apr. 20, 2023, which is hereby incorporated by reference, to the extent that it is not conflicting with the present application.

### BACKGROUND OF INVENTION

### 1. Field of the Invention:

The invention relates generally to infusion devices and specifically to devices configured to infuse terpenes, water, and other reagents into plant matter.

### 2. Description of the Related Art

Flowers and plants are often used as food, recreational materials, and/or decorative elements in many applications due to their often vibrant colors, pleasant aroma and simple upkeep. While many plants may be used for decoration and/or consumption, certain types of plants may struggle to achieve a desired type and level of aroma and/or taste due to a natural limitation of the plant, the plant being produced during the “off-season,” etc. While terpenes or similar materials may be capable of being introduced into plant matter in order to enhance the aroma or flavor of said plant matter, the lack of a fast, easy and effective way to fully infuse said materials into the core of plant matter has hampered the utilization of terpenes as an effective material for this purpose. Furthermore, there are not currently conventionally known devices for infusing terpenes or water into plant matter in order to improve its scent and smell, as well as hydrate said plant, respectively, particularly for large scale operations.

Therefore, there is a need to solve the problems described above by proving a device and method for infusing plants with terpenes, water and/or other reagents within a scalable apparatus.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description.

In an aspect, an infuser apparatus configured to infuse reagents into plant samples is provided, the infusion apparatus comprising: a reagent dispenser having a plurality of reagents, the reagent dispenser having: at least one reagent supply line, each reagent supply line having: a reagent injection syringe configured to hold a corresponding reagent of the plurality of reagents; a flow control valve in fluid communication with the reagent injection syringe; and a pinch valve in fluid communication with the flow control valve; a vaporizer feed line in fluid communication with each reagent supply line of the at least one reagent supply line; a vaporizer in fluid communication with vaporizer feed line; a vacuum chamber feed line in fluid communication with the vaporizer; a vacuum chamber in fluid communication with the vacuum chamber feed line; a vacuum pump in fluid communication with the vacuum chamber; and an infuser controller in electrical communication with the reagent dispenser, the vaporizer, the vacuum chamber and the vacuum pump; wherein flow of each reagent of the plurality of reagents from the reagent dispenser through the vaporizer feed line into the vaporizer and then through the vacuum chamber feed line into the vacuum chamber is controlled by the infuser controller, such that each reagent of the plurality of reagents is configured to be selectively infused into at least one plant sample disposed within the vacuum chamber. Thus, an advantage is that samples of plant matter/flowers disposed within the vacuum chamber may be infused with a selected reagent(s) quickly and easily. Another advantage is that the infusion apparatus may utilize a software component configured to operate the infusion apparatus automatically without requiring human intervention throughout the infusion process. Another advantage is that the infusion apparatus is configured to be resized or rescaled as necessary in order to achieve the desired chamber cavity volume to facilitate a desired throughput of infused samples. Another advantage is that terpenes, water and/or other reagents may be infused into plant matter simultaneously, thus saving time.

In another embodiment, an infusion apparatus configured to infuse reagents into a sample is provided, the infusion apparatus comprising: a reagent dispenser having at least one reagent: a vaporizer in fluid communication with the reagent dispenser; a vacuum chamber in fluid communication with the vaporizer; a vacuum pump in fluid communication with the vacuum chamber; and an infuser controller in electrical communication with the reagent dispenser, the vaporizer, the vacuum chamber and the vacuum pump; wherein flow of each reagent of the at least one reagent from the reagent dispenser through the vaporizer and into the vacuum chamber is controlled by the infuser controller, such that the at least one reagent is configured to be selectively infused into at least one sample stored within the vacuum chamber. Again, an advantage is that samples of plant matter/flowers disposed within the vacuum chamber may be infused with a selected reagent(s) quickly and easily. Another advantage is that the infusion apparatus may utilize a software component configured to operate the infusion apparatus automatically without requiring human intervention throughout the infusion process. Another advantage is that the infusion apparatus is configured to be resized or rescaled as necessary in order to achieve the desired chamber cavity volume to facilitate a desired throughput of infused samples. Another advantage is that terpenes, water and/or other reagents may be infused into plant matter simultaneously, thus saving time.

In another embodiment, a method of infusing a reagent into a sample within an infusion apparatus is provided, the infusion apparatus having a reagent dispenser having the reagent, a vaporizer in fluid communication with the reagent dispenser, a vacuum chamber in fluid communication with the vaporizer; a vacuum pump in fluid communication with the vacuum chamber; and an infuser controller in electrical communication with the reagent dispenser, the vaporizer, the vacuum chamber and the vacuum pump, the method of infusing the reagent into the sample within the infusion apparatus comprising the steps of: introducing the sample into the vacuum chamber; sealing the vacuum chamber; interacting with the infuser controller to actuate the vacuum pump, such that actuation of the vacuum pump produces a vacuum within the vacuum chamber; interacting with the infuser controller to actuate a heated wall within the vacuum chamber; interacting with the infuser controller to initiate flow of the reagent from the reagent dispenser, through the vaporizer, and into the vacuum chamber; and allowing the reagent to be infused into the sample disposed within the vacuum chamber. Again, an advantage is that samples of plant matter/flowers disposed within the vacuum chamber may be infused with a selected reagent(s) quickly and easily. Another advantage is that the infusion apparatus may utilize a software component configured to operate the infusion apparatus automatically without requiring human intervention throughout the infusion process. Another advantage is that the infusion apparatus is configured to be resized or rescaled as necessary in order to achieve the desired chamber cavity volume to facilitate a desired throughput of infused samples. Another advantage is that terpenes, water and/or other reagents may be infused into plant matter simultaneously, thus saving time.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates the front perspective view of an embodiment of a plant infuser, according to an aspect.

FIG. 2 illustrates the rear perspective view of vacuum chamber of the plant infuser, according to an aspect.

FIG. 3 illustrates the side perspective view of the base of the plant infuser, according to an aspect.

FIG. 4 illustrates the rear perspective view of the vacuum pump within the base of the plant infuser, according to an aspect.

FIG. 5A illustrates a front perspective view of a vacuum chamber having a plurality of shelves, according to an aspect.

FIG. 5B illustrates a front perspective view of a shelf within the vacuum chamber, according to an aspect.

FIG. 6 illustrates the rear perspective view of the vacuum chamber plant infuser, according to an aspect.

FIGS. 7A-7N illustrate the standard operating procedure for setting up of the plant infuser, according to an aspect.

FIGS. 8A-8X illustrate the standard operating procedure for manual operation of the plant infuser, according to an aspect.

FIGS. 9A-9U illustrate the standard operating procedure for automatic operation of the plant infuser, according to an aspect.

FIGS. 10A-10E illustrate the standard operating procedure for the shutting down of the plant infuser, according to an aspect.

FIG. 11 illustrates a schematic diagram of an alternative embodiment of the disclosed plant infuser, according to an aspect.

FIG. 12 illustrates a front perspective view of an alternative embodiment of the disclosed plant infuser, according to an aspect.

FIG. 13A-13B illustrate the side perspective views of a syringe receptacle, according to an aspect.

FIG. 14A-14B illustrate the front perspective views of a vacuum chamber with the chamber door closed and a vacuum chamber with the chamber door open, respectively, according to an aspect.

FIG. 15 illustrates the front perspective view of an infuser controller, according to an aspect.

FIG. 16 illustrates the front perspective view of a cold trap, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

It should be understood that, for clarity of the drawings and of the specification, some or all details about some structural components or steps that are known in the art are not shown or described if they are not necessary for the invention to be understood by one of ordinary skills in the art.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

For the following description, it can be assumed that most correspondingly labeled elements across the figures (e.g., 102 and 202, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

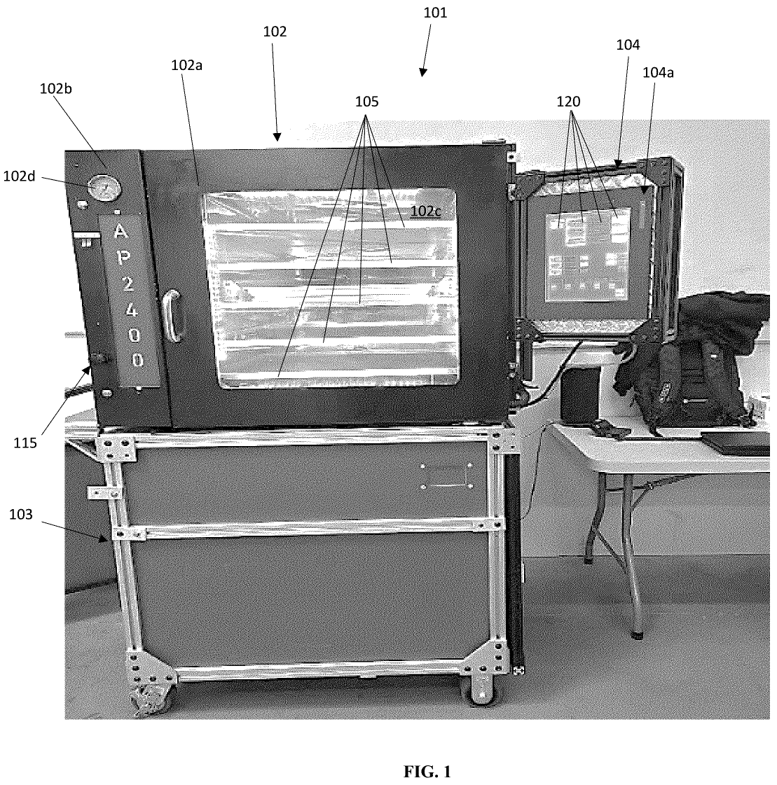

FIG. 1 illustrates the front perspective view of an embodiment of a plant infuser (“infusion apparatus”, “infuser”) 101, according to an aspect. The disclosed plant infuser 101 may be configured to infuse a flower and/or sample of plant matter with terpenes, water and/or other reagents, as applicable, through the process of “hyper-infusion” disclosed herein. The plant infuser 101 may be configured to infuse terpenes into plant matter to enhance the plant matter's aroma and taste through a vaporization, vacuum and hyper-infusion hold process which allows the terpenes to penetrate to the core of plant matter samples, which may be demonstrated on a cellular level. Additionally, the plant infuser 101 may also be configured to rehydrate plant matter samples through the same vaporization, vacuum and infusion process wherein water is introduced into the plant matter to rehydrate said plant matter back to the desired level. The “hyper-infusion” terminology disclosed herein may be referred to simply as “infusion” in the following disclosure for brevity.

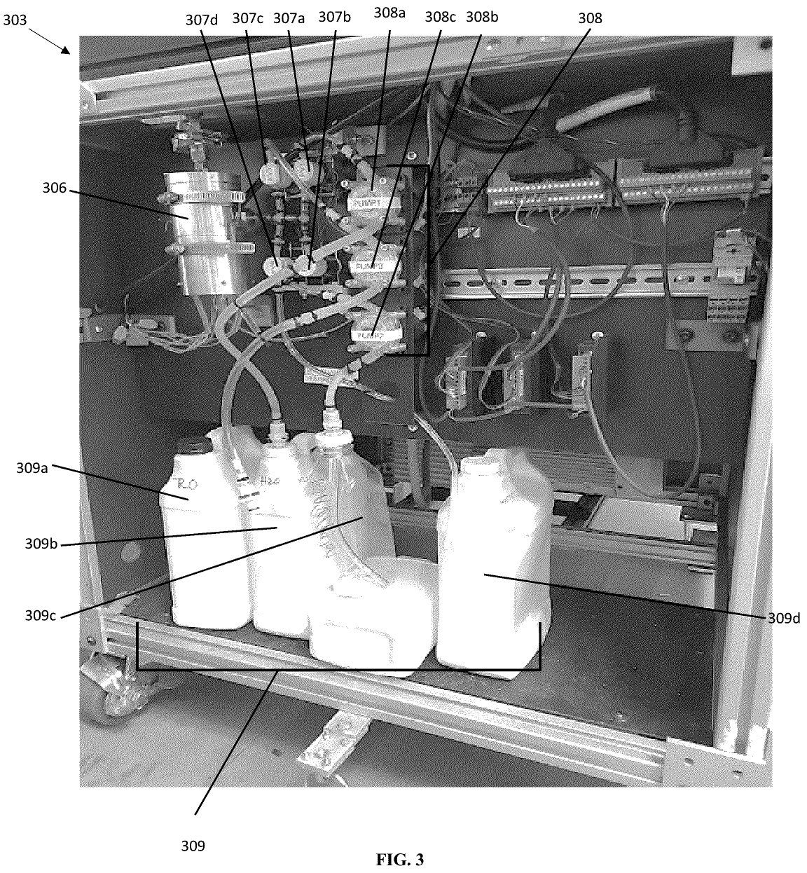

In an embodiment, the plant infuser 101 may comprise three main, interconnected structures, each of which will be disclosed in greater detail hereinbelow. These three main structures may include a vacuum chamber 102, a base 103 disposed below the vacuum chamber 102, and an infuser controller (“Programable Logic Controller”, “PLC”) 104 disposed next to the vacuum chamber 102. The vacuum chamber 102 and base 103 may both be in electronic communication with the infuser controller 104 to facilitate user control and/or automatic control of each applicable electrical element. Furthermore, the base 103 may be in fluid communication with the vacuum chamber 102 such that the vaporizer, such as vaporizer 306 of FIG. 3, is configured to inject a selected material vapor into the vacuum chamber for suitable infusion of said material into a plant, plant matter, flower, or other organic sample, such as tobacco products, cigars, pre-rolls, herbs and trim. For example, a prepared tobacco product, such as cigars and pre-rolled cigarettes may be suitably infused with terpenes, water vapor, etc., as necessary to provide the desired user experience.

The vacuum chamber 102 may be configured to create a suitable sealed environment for the infusion process detailed herein, when operating in conjunction with the base 103 and infuser controller 104. In an embodiment, the vacuum chamber 102 may be configured to maintain an internal vacuum of about 10 torr prior to the injection of the infusion material (“reagent”, “infusion reagent”), such as water or terpenes, into the vacuum chamber, in order to produce conditions in which said infusion materials may be infused into flower or plant matter at a suitable rate. As such, the vacuum chamber 102 must be sufficiently sturdy and airtight to achieve a suitable pressure to allow for the necessary infusion conditions. The vacuum chamber 102 may comprise a chamber body 102b configured to hold a plurality of samples, a chamber door 102a pivotally attached to the chamber body 102b, wherein the chamber door 102a may be configured to selectively seal a chamber cavity 102c formed within the chamber body 102b. In an embodiment, the vacuum chamber may further comprise a plurality of shelves 105 configured to engage with the chamber body 102b from within the chamber cavity 102c to provide additional surface space within the chamber cavity 102c to hold samples for the infusion process, as will be described hereinbelow. In an embodiment, the chamber door 102a may have a glass portion that allows a user to visually inspect the samples disposed within the vacuum chamber 102 during the infusion process, which may be helpful in ensuring proper device function.

In an embodiment, the chamber cavity 102c may be about 36 inches long and 36 inches wide, such that said vacuum chamber 102 is configured to securely engage with five shelves 105. In the same embodiment, each shelf 105 may be configured to hold a sample tray that may be about 21 inches long, 21 inches wide and 2 inches tall. In an alternative embodiment, the vacuum chamber 102 may have external dimensions of about 36 inches high, 30 inches wide and 29 inches deep, and internal dimensions (e.g., chamber cavity 102c dimensions) of about 24 inches high, 23.5 inches wide and 23.5 inches deep. In said alternative embodiment, each tray utilized within the vacuum chamber 102 may be about 2 inches high, 10.5 inches wide and 21 inches long, such that two trays may be put on each shelf. The vacuum chamber 102 may be further outfitted with a pressure gauge 102d nested within the chamber body 102b, wherein the pressure gauge 102d is configured to display the pressure of the environment within the chamber cavity 102c. It should be understood that that the dimensions of the disclosed vacuum chamber embodiment should not be considered limiting in nature, as the disclosed plant infuser 101, as well as the dimensions of its various structures, may be suitably modified and rescaled as necessary to achieve the required functional parameters and processing throughput. In an embodiment, the volume of the chamber cavity 102c may be increased in order to increase the number of samples that may be infused at the same time, while not notably changing the process utilized to infuse said samples.

In order to facilitate proper function of the plant infuser 101, the infuser controller 104 may be used to control electrical elements disposed within the base 103, such as the vaporizer and a vacuum pump, such as vacuum pump 410 of FIG. 4. A user may actuate these electrical elements by manipulating the corresponding control buttons 120 displayed on a control screen 104a of the infuser controller 104. In an embodiment, the infuser controller may have a control screen 104a having touch screen based control buttons 120 to allow for manipulation of the plant infuser operations (e.g., beginning the infusion process, setting operating parameters such as chamber pressure, etc.). In an alternative embodiment, the infuser controller 104 may have mechanical button (not shown) in lieu of, or in conjunction with, the touch screen based control buttons 120 of FIG. 1. It should be understood that the disclosed infuser controller 104 may operate based off of software configured to facilitate the controlling of the plant infuser 101 and its various operations through manipulation of the infuser controller 103 and its elements. The base 103, and its various elements, will be described in greater detail hereinbelow.

In order to facilitate the equalization of pressure within the chamber cavity 102c after an infusion/rehydration procedure, the vacuum chamber 102 may further comprise a manual vacuum release valve 115 engaged with the chamber body 102b. The manual vacuum release valve 115 may be configured to be actuated by a user to selectively vent air from the surrounding environment into the vacuum cavity 102c, in order to allow a user to equalize the pressure within the vacuum chamber 102 to easily open the chamber door 102a after procedure completion. In an embodiment, by actuating the manual vacuum release valve 115, selective fluid communication between the vacuum cavity 102c and the surrounding environment may be established as needed. 10039) Throughout the present disclosure, the term “fluid communication” may be utilized in describing the relationship between device structures. It should be understood that the disclosed plant infuser is configured such that liquids, gases or a combination thereof may flow between elements that are in “fluid communication” with each other. Furthermore, while the disclosed plant infuser 101 may be configured for the selective infusion of reagents into samples of plant matter, it should be understood that the disclosed plant infuser 101 may also be referred to as an “infusion apparatus”, and utilized for the infusion of reagents into samples that are not necessarily plants/plant matter.

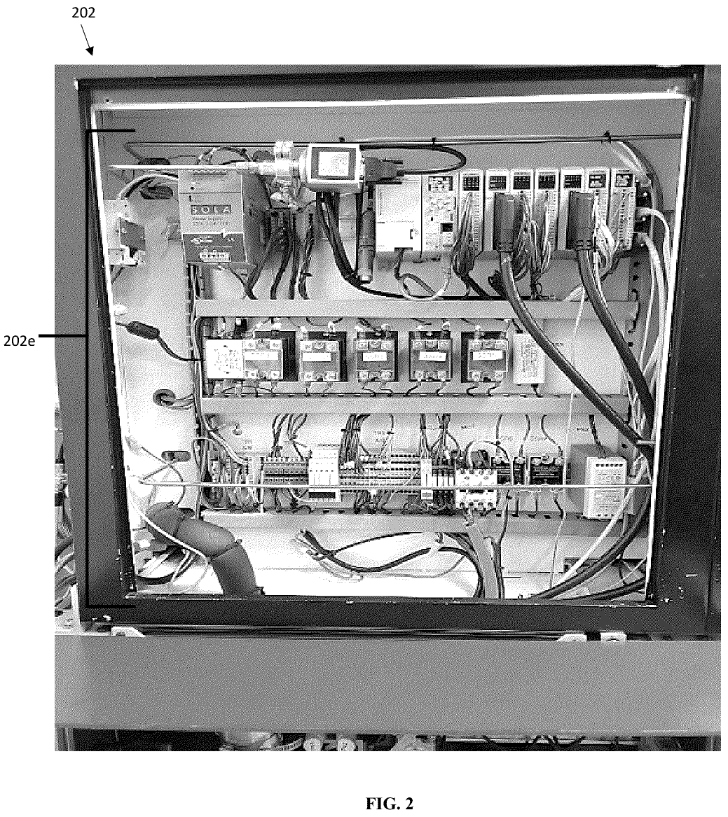

FIG. 2 illustrates the rear perspective view of vacuum chamber 202 of the plant infuser, according to an aspect. As disclosed hereinabove the vacuum chamber 202 of the plant infuser may be configured to house a sample for infusion. In addition, the vacuum chamber 202 may comprise a control box 202e configured to house the majority of the electrical elements of the vacuum chamber 202. It should be understood that the main function of the control box 202e is to facilitate communication between the PLC 104 of FIG. 1, and the instrumentation of the base disclosed hereinbelow, including the pinch valves 307a-307d and reagent pumps 308 of FIG. 3, such that the commands of the PLC 104 are executed by said instrumentation of the base. The control box may 202e be in electrical communication with both the infuser controller and the base, such as infuser controller 104 and base 103 of FIG. 1, in order to facilitate the execution of commands on the infuser controller resulting in actuation of corresponding elements within the base to perform the necessary operations to the infusion materials/reagents and the contents of the vacuum chamber 202. The control box 202e may comprise known electrical elements to facilitate the function of the plant infuser as described herein.

It should be understood that the various elements of plant infuser may be controlled by a software component configured to operate the various electrical and mechanical components disclosed herein, including the control box 202e. This software component may be accessed and interfaced with by a user through the disclosed infuser controller, configured to operate the infusion controller automatically without human intervention, or allowed to be semi-automated.

FIG. 3 illustrates the side perspective view of the base 303 of the plant infuser, according to an aspect. As disclosed hereinabove, the base 303 may be configured to house various electrical and mechanical structures responsible for facilitating many of the relevant functions of the plant infuser. The base 303 may comprise a vaporizer 306 in fluid communication with a plurality of reagent pumps 308, a plurality of reagent containers 309 and the chamber cavity, such as chamber cavity 102c of FIG. 1. The base 303 may further comprise a plurality of pinch valves 307a, 307b, 307c, 307d in fluid communication with the plurality of reagent pumps 308 and the plurality of reagent containers 309. These pinch valves 307a-307d may be configured to allow or restrict (e.g., selectively allow) the flow of corresponding reagents to allow for the mixing of each of the reagents in the desired amounts prior to vaporization and subsequent injection into the chamber cavity.

The plurality of reagent containers 309 may include a terpene container 309a, a water container 309b, a supplemental reagent container 309c and a waste container 309d. It should be understood that supplemental reagent container 309c may contain any reagent necessary for infusion, including additional terpenes. In an embodiment, the terpene container 309a, water container 309b and supplemental reagent container 309c may be in fluid communication with a corresponding first reagent pump 308a, second reagent pump 308b, or third reagent pump 308c, to facilitate transportation of each corresponding reagent to the vaporizer 306. The waste container 309d may be configured to collect runoff, but may also be utilized to prime the corresponding line. In an embodiment, the terpene container 309a may be in fluid communication with the third reagent pump 308c, the water container 309b may be in fluid communication with the first reagent pump 309a, and the supplemental reagent container may be in fluid communication with the second reagent pump 308b.

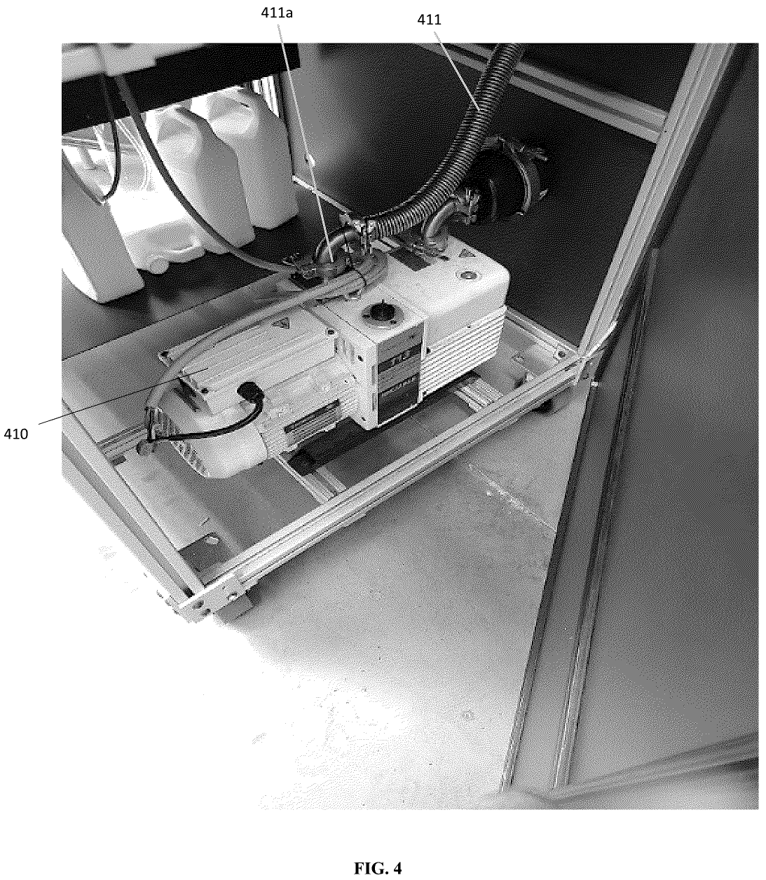

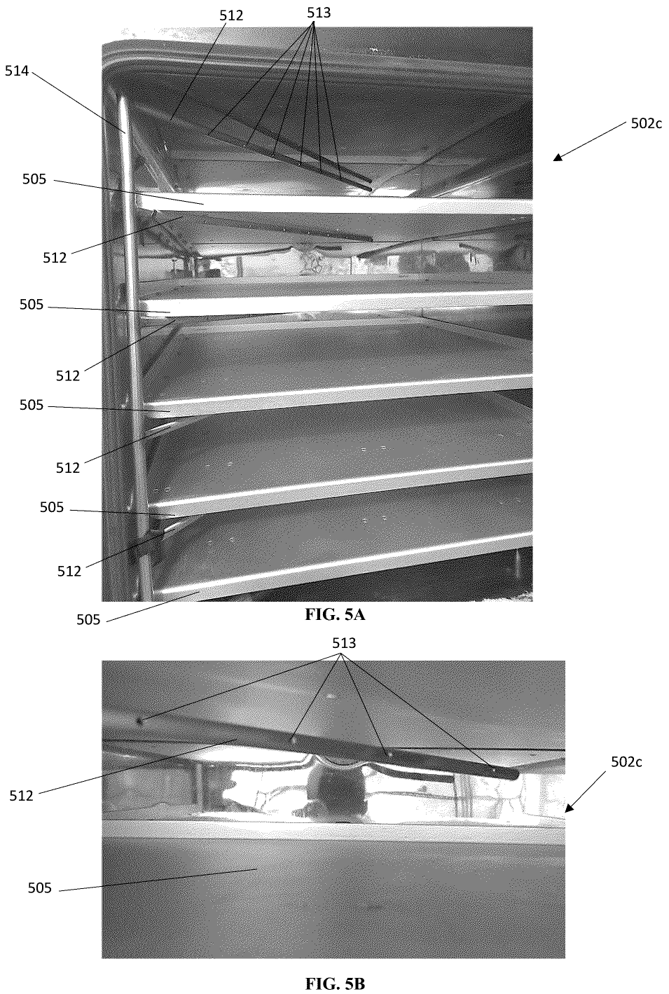

Each reagent pump 308a, 308b, 308c of the plurality of reagent pumps 308 may also be in fluid communication with a corresponding pinch valve 307a, 307b, 307c, respectively, whereas the remaining pinch valve, pinch valve 307d may be used for the purpose of overflow and waste control and thus may be referred to as a waste flow valve 307d. As such, said waste flow valve 307d may be configured to allow the overflow/waste control aspects of the plant infuser to function properly. By opening the waste flow valve 307d, a user may be allowed to prime or overflow the pipes/lines of the plant infuser, as necessary, and when placed under vacuum, the waste flow valve 307d may allow a natural occurrence of pressure to force air through the tubing that is in the vacuum chamber, such as the distribution arms 512 of FIG. 5. The waste flow valve 307d may thus be configured to clear any extra reagents trapped within the pipes/lines of the plant infuser prior to beginning another infusion procedure.

In contrast to the other reagent containers 309a, 309b, 309c, the waste container 309d may be in direct fluid communication with a corresponding waste flow valve 307d, to allow for the collection of waste fluids as described hereinabove. The plurality of pinch valves 307a-307d may be in fluid communication with the vaporizer 306, such that vaporization and subsequent delivery of the created reagent or reagent mixture to the chamber cavity is facilitated. It should be understood that different embodiments of the base 303 may also be realized based upon the disclosure provided herein, so long as the base 303 is configured to allow for the delivery of vaporized reagents to the chamber cavity as disclose herein.

It should be understood that fluid communication between elements may be facilitated through the usage of appropriate tubing/piping, as necessary. For example, the fluid communication between the first pump 308a and the first pinch valve 307a may be facilitated by a corresponding plastic tube in fluid communication with the first pump 308a and the first pinch valve 307a. In another example, fluid communication between the vaporizer 306 and the vacuum chamber may be facilitated by a suitable metal pipe, such as stainless steel piping, rather than a plastic tube, given the increased temperature of reagents exiting the vaporizer. Suitable fluid communication mechanisms may be utilized in between each applicable element in order to suitably facilitate device function as disclosed herein.

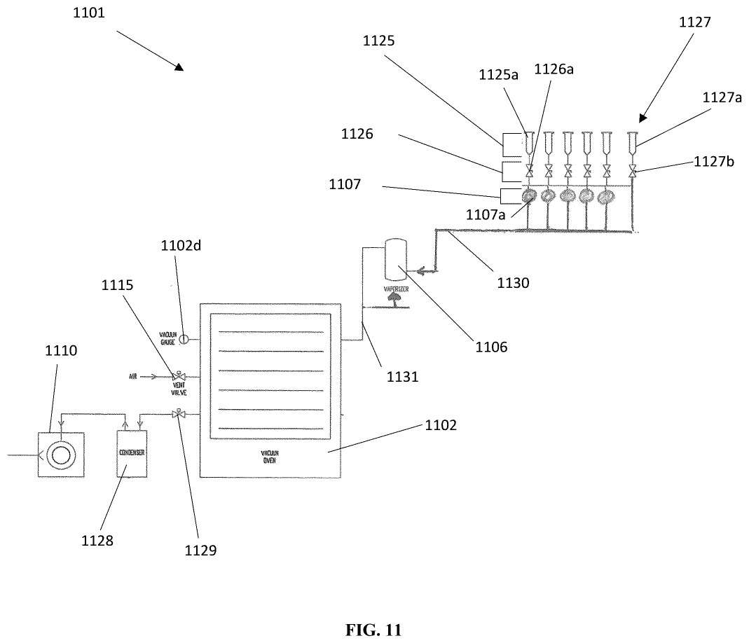

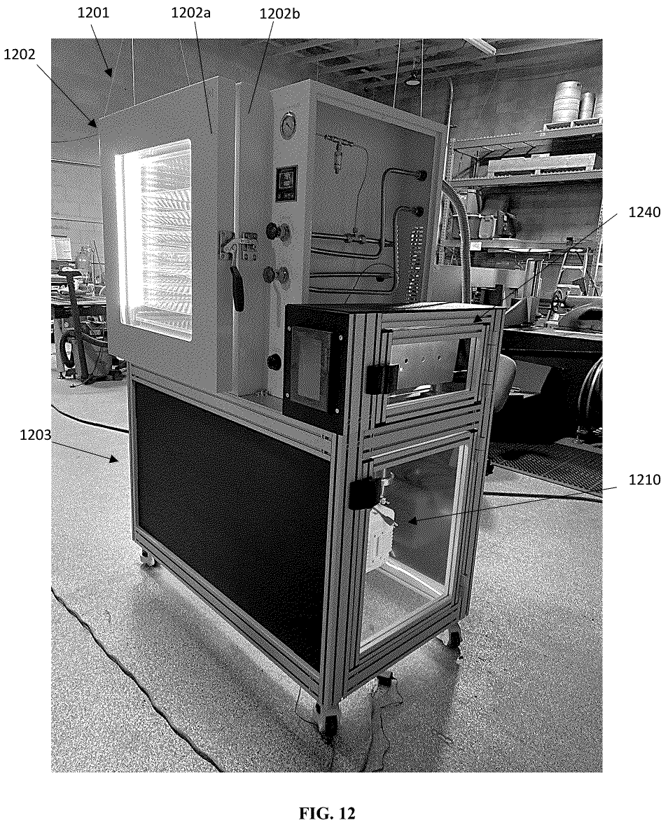

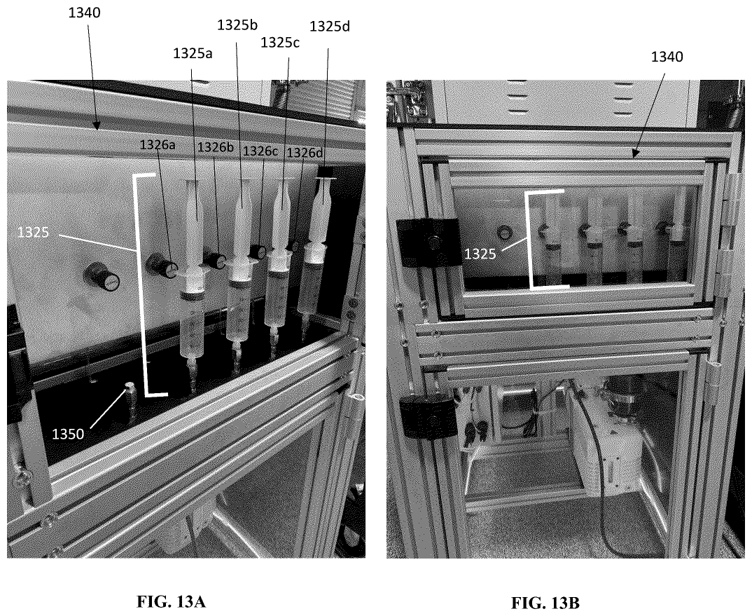

In an embodiment, the combination of elements configured to control the flow of reagent(s) to the vaporizer 306 may be referred to as a reagent dispenser. In an embodiment, the reagent dispenser may comprise a reagent container 309a, a corresponding reagent pump 308a in fluid communication with the reagent container 309a, and a corresponding pinch valve 307a in fluid communication with the reagent pump 308a. As is understood, a plurality of each element may be implemented to allow for multiple reagents to be distributed to the vaporizer 306. For example, the reagent dispenser may comprise a plurality of reagent containers 309a-309c, a plurality of reagent pumps 308a-308c, each reagent pump 308a-308c being in fluid communication with a corresponding reagent container 309a-309c, and a plurality of pinch valves 307a-307c, each pinch valve 307a-307c being in fluid communication with a corresponding reagent pump 308a-308c. It should be understood that the specific quantity and identity of reagents distributed, as well as the types of functional elements used within the reagent dispenser may vary between reagent dispenser embodiments, as will be seen in greater detail hereinbelow in FIG. 11.

FIG. 4 illustrates the rear perspective view of the vacuum pump 410 within the base of the plant infuser, according to an aspect. In order to establish suitable pressure conditions within the vacuum chamber during operation, a vacuum pump 410, or other suitable vacuum source, may be utilized. It is critical for the infusion process to establish suitable pressure conditions within the chamber cavity to ensure that substances injected into the chamber cavity from the vaporizer may be properly infused into the samples stored within the chamber cavity. The vacuum pump 410 may be in fluid communication with the vacuum chamber (e.g., the vacuum generated by the vacuum pump will be experienced within the chamber cavity) through the utilization of a vacuum line 411, wherein a first end 411a of the vacuum line 411 is configured to be engaged with the vacuum pump 410 and a second end (not shown) of the vacuum line 411 is configured to be engaged with the vacuum chamber. In addition to establishing and maintaining suitable pressure conditions within the chamber cavity using the disclosed vacuum pump 410, it may also be necessary to establish suitable temperature controls within the chamber cavity, which may be facilitated through conventional heating mechanisms, such as utilizing resistive heating elements. In an embodiment, the chamber cavity and sample trays may be maintained at a temperature of about 99 degrees Fahrenheit to about 100 degrees Fahrenheit during the infusion process.

The process of infusing plant matter with a desired infusion material/reagent may begin with preparing the plant matter on a sample tray and inserting the sample tray into the chamber cavity. Upon insertion of the sample tray into the chamber cavity, and closing of the chamber door to seal the chamber cavity, a user may begin manipulating the appropriate controller buttons on the infusion controller, such as infusion controller 104 of FIG. 1, to begin plant infuser operation. The infusion controller may be configured to actuate the aforementioned vacuum pump 410 in order to achieve the required pressure conditions within the chamber cavity for the infusion process to be performed, wherein the pressure conditions within the vacuum chamber may be selectively or passively adjusted or maintained throughout the infusion process as necessary based upon user input commands, predefined operational procedures as part of the software component, the structure of the vacuum chamber, etc. In an embodiment, the vacuum chamber may be brought to and maintained at 10 torr for the entirety of the infusion process, depending on the reagent being infused into the plant matter. In an alternative embodiment, the vacuum chamber may be brought down to roughly 10 torr at the beginning of the infusion process, but by the end of the infusion process the chamber may raise to about 20 to 30 torr. By maintaining a low pressure within the chamber cavity, reagent vapors injected into the chamber cavity by the vaporizer may be efficiently pulled into and thus infused within the plant matter or other sample over a relatively short time frame.

Upon achieving the necessary pressure conditions to begin the infusion process, the infuser controller may be further configured to actuate the plurality of reagent pumps, such as reagent pumps 308a-308c of FIG. 3, within the base in order to suitably pump the necessary reagent materials from their corresponding reagent containers into the vaporizer for vaporization. Upon vaporization of the desired reagent(s), said reagent(s) may be configured to be injected into the chamber cavity in the proper volume(s), temperature and speed to generate a vapor or mist that is nano-emulsified under the vacuum pressure conditions of the chamber cavity, thus allowing the reagent(s) to be introduced into the core of the plant matter for proper and efficient infusion. In an embodiment, the entire infusion process may take about 10 to 12 minutes, depending on the identity and quantity of the reagent(s) being used, as well as the pressure conditions established within the chamber cavity. Upon completion of the infusion process, the vacuum pump may be disengaged by the user by manipulating the infusion controller or automatically by virtue of hitting a time limit or a certain condition within the vacuum chamber, if corresponding sensory equipment is utilized within the vacuum chamber to facilitate automated operation of the plant infuser.

As disclosed hereinabove, infusion of terpenes into plant matter may be performed in order to improve or enhance the aroma and/or taste of plant matter/flowers. In an embodiment, the reagent being injected into the vacuum chamber for infusion into plant matter may be terpenes. In said embodiment, the vacuum chamber may be brought under vacuum such that the pressure within the chamber is about 10 torr. Prior to being injected into the vacuum chamber, the terpenes may be heated to about 200 to 240 degrees Fahrenheit in the vaporizer in order to allow for the liquid terpene reagent to be converted into terpene vapor prior to infusion. A corresponding reagent pump, such as the second reagent pump 308b of FIG. 3, may be used to transport the terpenes from the corresponding terpene regent container 309a to the vaporizer 306 and from the vaporizer 306 into the vacuum chamber. Upon being injected into the vacuum chamber, the terpene vapors may be infused into plant matter or other samples stored within the vacuum chamber. In general, the volume of the hydration or terpenes added to the line feeding into the pump, vaporizer and chamber varies depending on the severity of the lack of smell (aroma) and/or taste of the flower/plant matter being treated. In an embodiment, for general aroma enhancement, the volume of terpene reagent used per weight of plant matter may be about 1 mL of terpene for 1 lbs. of plant matter.

In an embodiment, in order to allow for the rehydration of plant matter within the plant infuser, water may be utilized as the reagent for the infusion process. The infusion of water into plant matter for rehydration may also be performed under chamber conditions similar to those used for terpene infusion, wherein the pressure within the chamber cavity may be brought to about 10 torr prior to injection of the water into the vacuum chamber. In said embodiment wherein water is to be infused into the plant matter, the water may be heated to 300 degrees Fahrenheit in the vaporizer to allow for its vaporization prior to being injected into the vacuum chamber. Similarly to the above described terpenes, a water reagent container, such as water reagent container 309b of FIG. 3, may be in fluid communication with a corresponding pump, such as the first reagent pump 308a, to facilitate the transportation of the water reagent from a corresponding water reagent container 309b to the vaporizer 306, and from the vaporizer 306 into the vacuum chamber. In an embodiment, a separate mechanism for providing pressure for the injection of the reagents from the vaporizer to the vacuum chamber may be provided, to help control the infusion of the reagents into the reagent chamber. This separate mechanism for providing pressure for the injection of the reagents from the vaporizer to the vacuum chamber may be provided in the form of at least one transport pump (not shown) that is the same or similar to the type of pump utilized for the prior disclosed reagent pumps 308a, 308b, 308c. Each transport pump may be made of materials such as plastics, wherein the transport pump(s) may be provided as a singular, unified transport pump, or on a per reagent basis (e.g., a transport pump for each vaporized reagent or specific group of vaporized reagents) to facilitate the transport of the vaporized reagents to the vacuum chamber.

In general, the volume of the hydration added to the corresponding line feeding into the pumps, vaporizer and vacuum chamber varies depending on the severity of the dehydration of the flower/plant matter being treated. In an embodiment, the volume of water reagent used per weight of plant matter to allow for sufficient rehydration of said plant matter may be about 6 mL of water per 1 lb of plant matter. It should be understood that certain embodiments may require more or less water per pound of plant matter, depending on the characteristics of the plant matter, current level of dehydration in the plant matter, desired level of rehydration, etc. In an embodiment, the vaporizer may vaporize a mixture of terpenes and water at a temperature of about 240 to about 250 degrees Fahrenheit prior to injecting the vaporized mixture into the vacuum chamber, thus allowing both reagents to be infused simultaneously.

As disclosed hereinabove, the process of infusing terpenes or water into a desired sample may be summarized in several steps. First a sample(s) (flower, plant matter, etc.) may be added to a sample tray and placed within the chamber cavity of the vacuum chamber. After closing the door and sealing the vacuum chamber, the vacuum pump 410 may be activated through manipulation of the infusion controller to vacuum the chamber cavity down to the desired pressure level, such as 10 torr, as disclosed hereinabove. Upon achieving the desired pressure level, the corresponding reagent pump(s) may be actuated to begin pumping the desired infusion reagent(s) into the vaporizer for vaporization. Upon the heating and subsequent vaporization of the selected infusion reagent or combination of infusion reagent, said infusion reagents may be pumped up to the infusion chamber and injected into the infusion cavity. The time required for the injected infusion reagents to be infused into the sample may vary based on the properties of the sample(s), infusion reagent(s) being used, volume of infusion reagent being used, etc., but in a preferred embodiment, it may take 6-10 minutes to fully infuse the sample with the reagent(s) while maintaining the chamber cavity at the desired pressure level. Upon fully infusing the sample(s), the vacuum pump may be disengaged (either manually by a user manipulating the infusion controller or automatically by virtue of the described programming) and the pressure of the infusion cavity may be allowed to equalize to ambient pressure. Finally, the now infused samples may be removed from the chamber cavity for processing, packaging or any other steps required prior to use.

It should be understood that modifications to the above process may be made while remaining within the scope of the disclosed plant infusion process. The usage of different infusion times (the time required to infuse the injected infusion reagents into the sample), different cavity pressures, different vaporizer temperatures, etc., may be necessitated or otherwise desired depending on the infusion reagent(s) being used for infusion and the amount infusion reagents being used, amongst other potential variations that may be envisioned in light of the present disclosure. For example, a greater infusion time may be required if a greater volume of infusion reagent is being used, or if some characteristic of the infusion reagent or sample for whatever reason would slow the infusion process.

The disclosed plant infuser may use the disclosed hyper-infusion hold process in order to achieve the desired infusion of reagents into a desired sample, for purposes of hydrating the sample (when using water as a reagent) or improving the aroma and/or taste of the sample (when using terpenes as the reagent). The disclosed process may be configured to infuse large batches of flowers or plant matter samples quickly and easily with minimal human intervention through the usage of a suitable software components and known automation techniques. It should also be understood that other types of samples other than flower/plant matter may also be infused using the disclosed plant infuser, as long as said samples may withstand the pressure conditions exerted on them while within the cavity chamber during plant infuser operation.

FIG. 5A illustrates a front perspective view of a vacuum chamber 502 having a plurality of shelves 505, according to an aspect. FIG. 5B illustrates a front perspective view of a shelf 505 within the vacuum chamber, according to an aspect. After being vaporized within the vaporizer, but prior to their injection/dispersion into the chamber cavity 502c, reagents may travel through one of a plurality distribution arms 512. A plurality of distribution arms 512 may be in fluid communication with that vaporizer and positioned within the vacuum chamber such that each distribution arm is disposed above a different shelf 505. By having a corresponding distribution arm 512 disposed above each shelf, even distribution of the reagents to the shelved samples may be facilitated, regardless of sample position.

Each distribution arm 512 may have a plurality of distribution ports 513, such that a reagent(s) may enter the distribution arm from the vaporizer and be injected into the chamber cavity 502c via one of a plurality of distribution ports 513 nested within the distribution arm 512. In an embodiment, the vaporizer, such as vaporizer 306 of FIG. 3, may be in fluid communication with a main reagent line 514, wherein the main reagent line 514 is in fluid communication with each distribution arm 512, such that reagents are configured to travel from the vaporizer into the main reagent line 514 then into the plurality of distribution arms 512, before being injected into the chamber cavity 502c through a corresponding distribution port 513. Through this disclosed distribution mechanism, reagents may be uniformly distributed to samples disposed on each shelf of the vacuum chamber, thus ensuring products are infused uniformly. In an embodiment, each distribution arm 512 as well as the main reagent line 514 may be made of stainless steel, or another non-reactive material configured to carry high temperature reagents for distribution.

In addition to each shelf 505 having its own distribution arm for receiving reagents, each shelf 505 of the plurality of shelves 505 may also be provided with its own temperature controller. Each shelf may be outfitted with a suitable heater and temperature gauge (not shown) wired into a back portion of said shelf to facilitate the heating of the trays thus the held sample(s). In an embodiment, a plurality of heated walls (such as heated wall 1402g of FIG. 14B) disposed within the vacuum chamber may be configured to control the internal temperature of the vacuum chamber, and thus the temperature of the contained samples. The temperature of each shelf may be controlled by the PLC though conventional temperature control mechanisms known in the industry. The temperature gauge for each shelf may be in data communication with the PLC to facilitate the monitoring and controlling of the temperature of each shelf 505, as well as the chamber cavity itself.

In an embodiment, additional functional elements may be disposed within the chamber cavity 502c in order to help circulate and transmit the vaporized reagents into the plant matter (or other material) disposed within the chamber cavity 502c. In said embodiment, at least one fan (not shown) may be disposed within the chamber cavity 502c, wherein the at least one fan is configured circulate the vaporized reagents, such as terpenes and water vapor, within the chamber cavity 502c in order to aid the diffusion process. In order to facilitate efficient circulation and transmission of the vaporized reagents, a singular fan may be positioned in a suitable location to help circulate the reagents throughout the entirety of the chamber cavity 502c, or multiple fans may be disposed in different locations within the chamber cavity 502c, such as on each shelf 505, to aid circulation and transmission of the reagents on a shelf-by-shelf basis.

FIG. 6 illustrates the rear perspective view of the plant infuser 601, according to an aspect. As disclosed hereinabove, the plant infuser may comprise a vacuum chamber 602 disposed above a base 603. The vacuum chamber may have a control box 602e configured to facilitate communication between the elements of the base 603, such as the vaporizer 606, and the PLC, such as PLC 104 of FIG. 1. Also the prior disclosed vacuum pump, such as vacuum pump 410 of FIG. 4, may be in fluid communication with the vacuum chamber 602 using the disclosed vacuum line 611, thus allowing the chamber cavity to be dropped to the necessary pressures to facilitate hyper-infusion as disclosed hereinabove. This vacuum pump may also be in electrical communication with the PLC, such as PLC 104 of FIG. 1, to enable the vacuum pump to be controlled and monitored, as necessary.

As can be seen in FIG. 6, the vacuum chamber 602, or more specifically the chamber cavity, may also be in fluid communication with an argon valve 616. This argon valve 616 may be configured to connect to an argon tank, wherein the argon valve 616 is configured to control gas flow (argon) from the argon tank to keep exhaust from the chamber cavity from contaminating the surrounding air. Additionally, a circuit breaker power switch 617 may be disposed on the outside surface of the vacuum chamber 602 for easy access by a user. Said circuit breaker power switch 617 may be configured to control power flow to a corresponding circuit breaker, and may be separate from a main power switch (not shown) located elsewhere on the plant infuser.

Furthermore, each applicable electrical element contained within the base 603, such as the vaporizer 606, reagent pumps, such as reagent pump 308a-308c of FIG. 3, etc. may be in electrical communication with the control box 602e, and thus in electrical communication with the PLC, to facilitate control of all applicable electrical elements of the base, to facilitate, pumping, vaporization and distribution of reagents, as well as vacuum operation as disclosed hereinabove. It should be understood that each electrical element may be suitably attached to a power source as needed, wherein an electronics power supply line 618 may be configured to connect each electrical element to a corresponding power supply to enable plant infuser operation. The power supply itself may be powered by a standard wall outlet, or any other suitable power source.

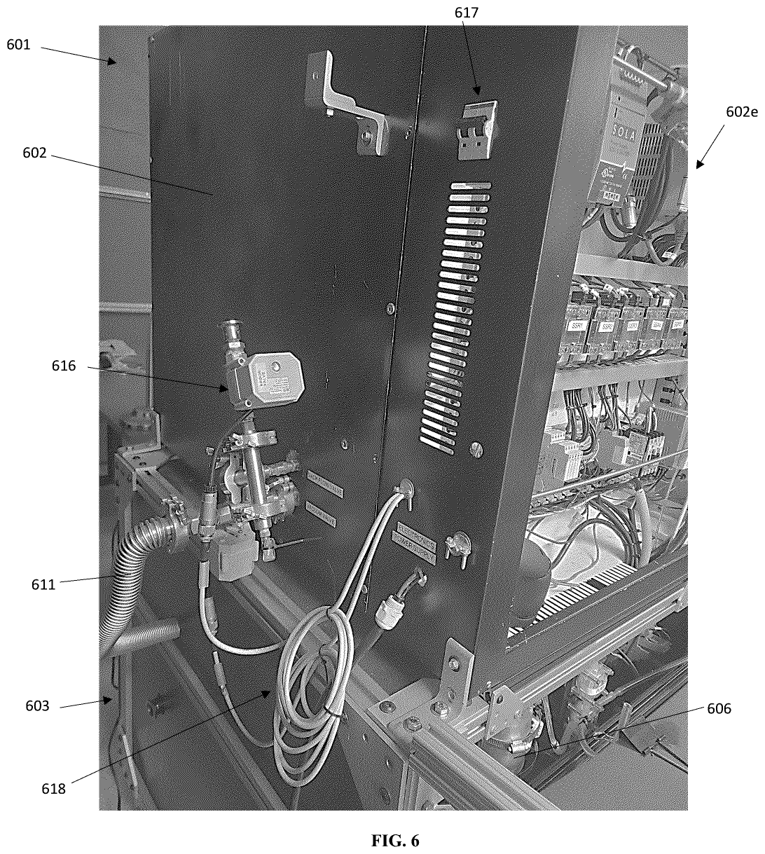

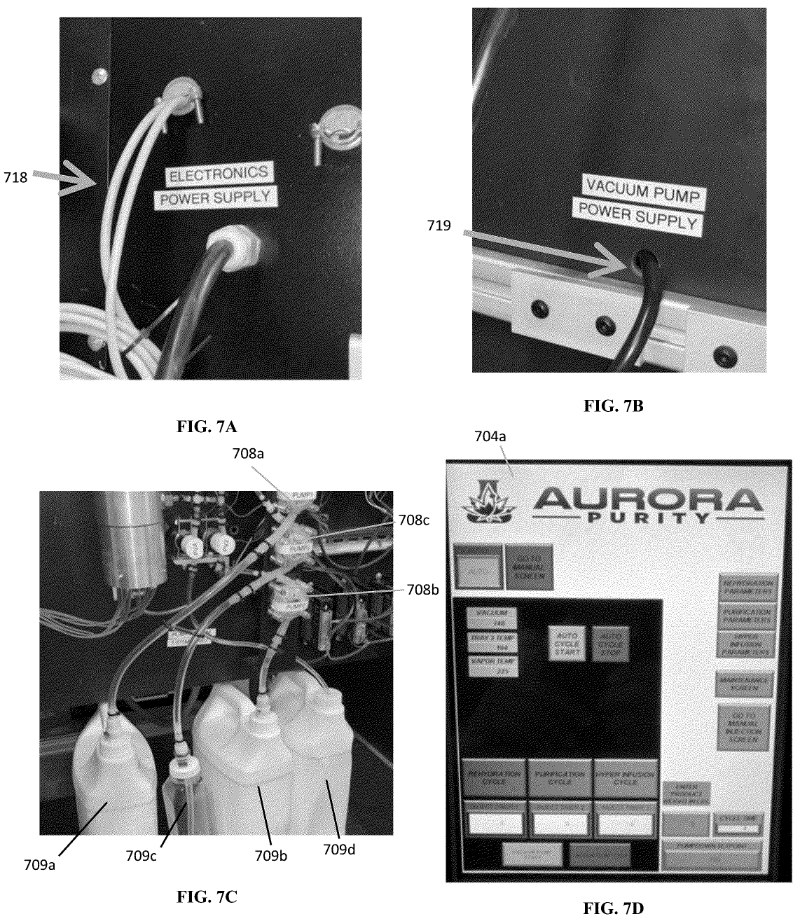

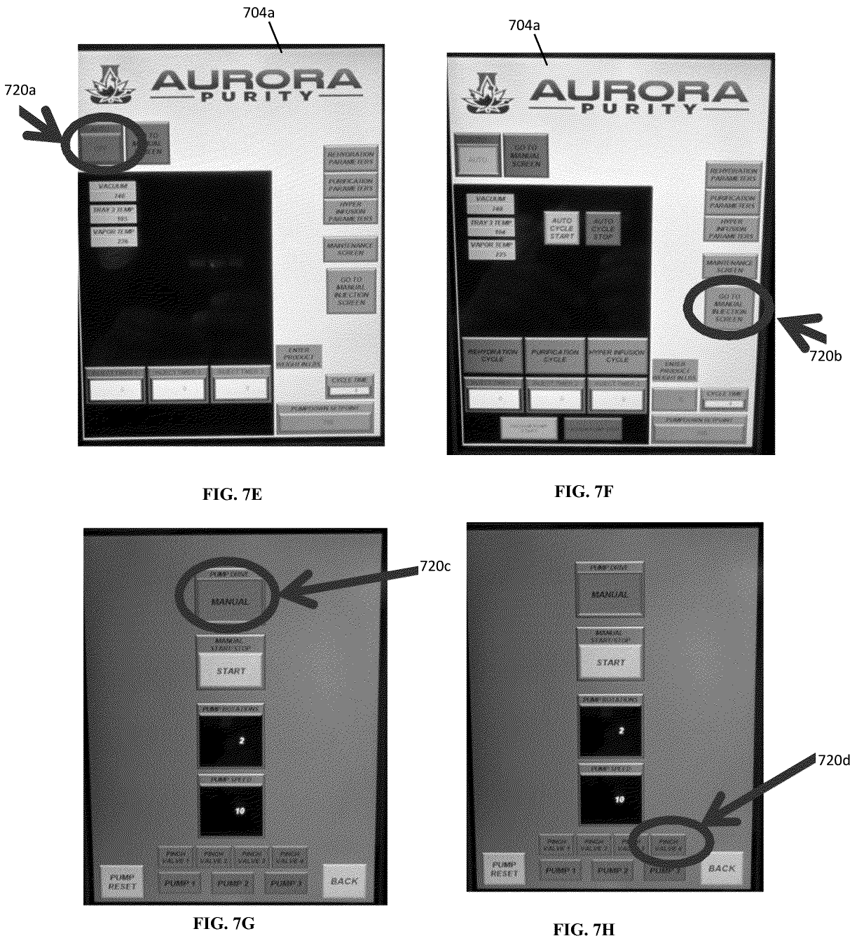

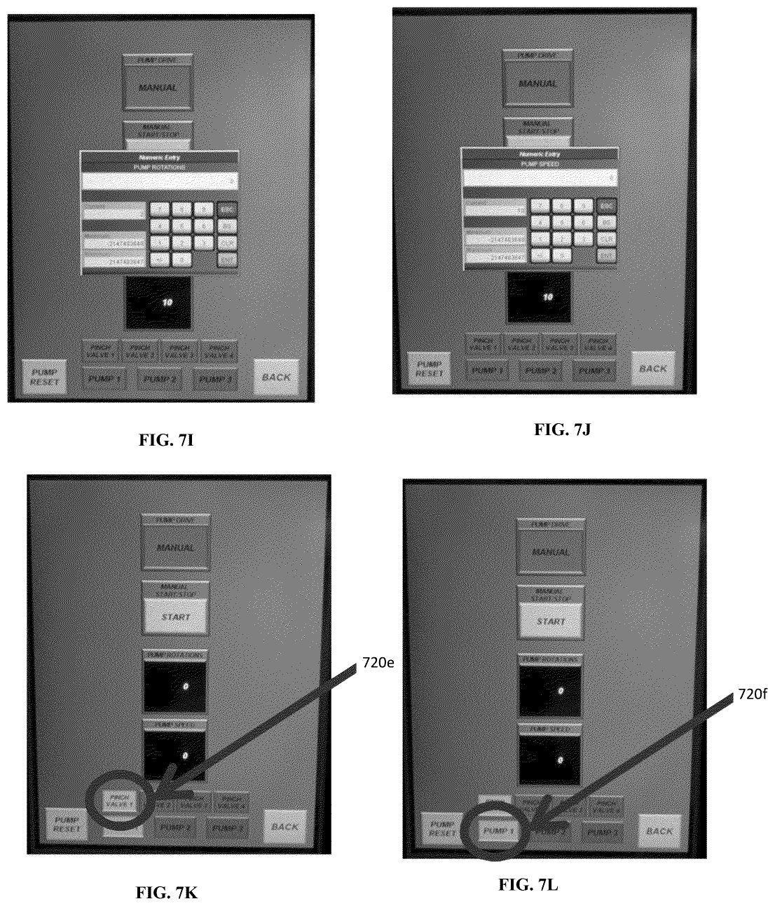

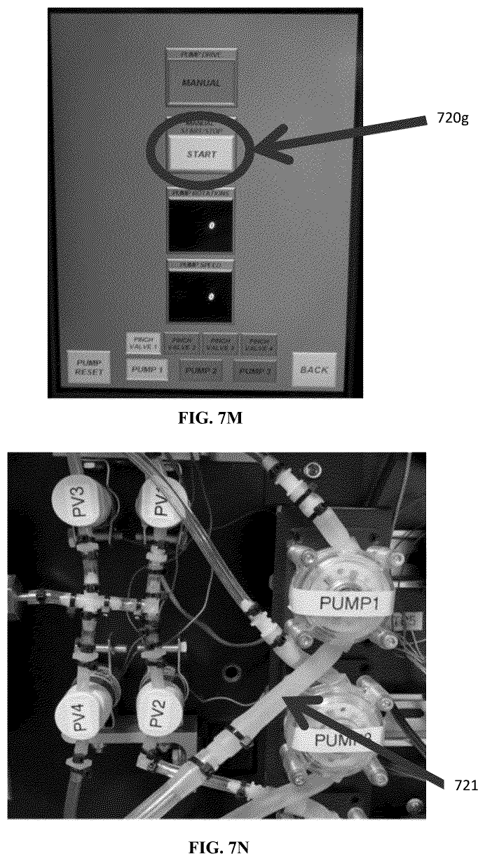

FIGS. 7A-7N illustrate the standard operating procedure for setting up of the plant infuser, according to an aspect. It should be understood that while the steps provided herein may be provided in sequential order for each standard operating procedure disclosed herein, obvious modification to step and step orders may be implemented depending on the needs of the application. In certain embodiments, steps may also be added or omitted depending on the current operation status of the plant infuser, desired infusion conditions, etc.

To begin the setup procedure for the plant infuser, a user may position the plant infuser near a dedicated 20 amp circuit for powering the vacuum pump and a standard wall power outlet for powering the other electronics of the plant infuser. The user may proceed by connecting the electronics power supply line 718 of FIG. 7A to a standard wall outlet (not shown) and connecting the vacuum pump power supply line 719 of FIG. 7B to the dedicated 20 amp outlet (not shown). The user may continue by filling the reagent containers 709a, 709b, 709c with the appropriate reagents and connecting each reagent container to a corresponding reagent pump 708a, 708b, 708c, as disclosed hereinabove and shown FIG. 7C. For safety, a user may wear appropriate personal protective equipment (“PPE”) including, but not limited to, splash goggles, rubber gloves and a suitable apron while handling the reagent chemicals. In an embodiment, the first reagent container 709a may be filled with a first volume of water and attached to the first reagent pump 708a, the second reagent container 709b may be filled with a second volume of terpene solution and attached to the second reagent pump 708b, and the third (supplemental) reagent container 709c may be filled a third volume of hydrogen peroxide (H₂O₂) and attached to the third reagent pump 708c.

After preparing the reagents as disclosed hereinabove, the user may power on the plant infuser using the main power switch (not shown) and allow it to boot up, such that the main screen, as seen in FIG. 7D, is visible is visible on the control screen 704a. The user may proceed with the preparations by ensuring the main screen is in the manual control mode by toggling the MANUAL CONTROL button 720a seen in FIG. 7E and then selecting the GO TO MANUAL INJECTION SCREEN button 720b seen in FIG. 7F. Upon reaching the manual injection screen of FIG. 7G, the user may select the PUMP DRIVE button 720c to set it to manual and then select the PINCH VALVE 4 button 720d as seen in FIG. 7H. The user may be prompted to set the pump rotation as seen in FIG. 7I and to set the pump speed as seen in FIG. 7J. In an embodiment, for a desired reagent flowrate of 6 mL/min while utilizing a corresponding reagent pump configured to deliver 2 mL per rotation, the pump speed may be set to three rotations per minute. In an alternative embodiment, the pump speed may be varied in accordance with the effectiveness of the vaporizer. In an alternative embodiment, as will be discussed hereinbelow, a faster flowrate may be established for an alternative plant infuser that utilizes flow control valves (such as flow control valve 1126 of FIG. 11), in conjunction with the vacuum pump to control reagent flow to the vacuum chamber, rather than individual, peristaltic, reagent pumps for each reagent.

The process described hereinbelow in FIG. 7K-7N may be described as the “priming process”. As seen in FIG. 7K the user may select the PINCH VALVE 1 button 720e to prime the corresponding line attached to the first pinch valve. The user may then select the PUMP 1 button 720f as seen in FIG. 7L and press the MANUAL START/STOP button 720g of FIG. 7M. The user should then observe the corresponding line 721 being primed, accordingly, as seen in FIG. 7N, wherein the liquid should exit into the waste container 709d through the corresponding fourth pinch valve. More rotations may be added as necessary, in addition to the 13 it was set to hereinabove. The pump may also be stopped prematurely by pressing the MANUAL START/STOP button 720g of FIG. 7M. This priming process may be repeated for each pinch valve and reagent pump by pressing their corresponding buttons seen in FIGS. 7K-7L. Finally, the user may return to the main screen of FIG. 7D by pressing the corresponding “BACK” button(s), where applicable, until the main screen is reached, to begin either manual or automatic operations.

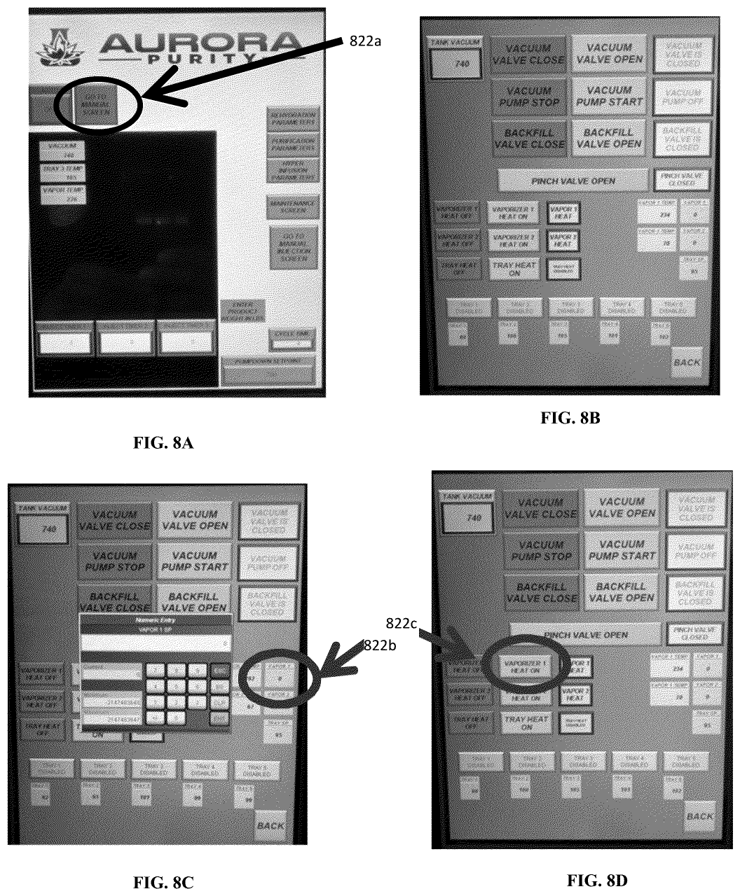

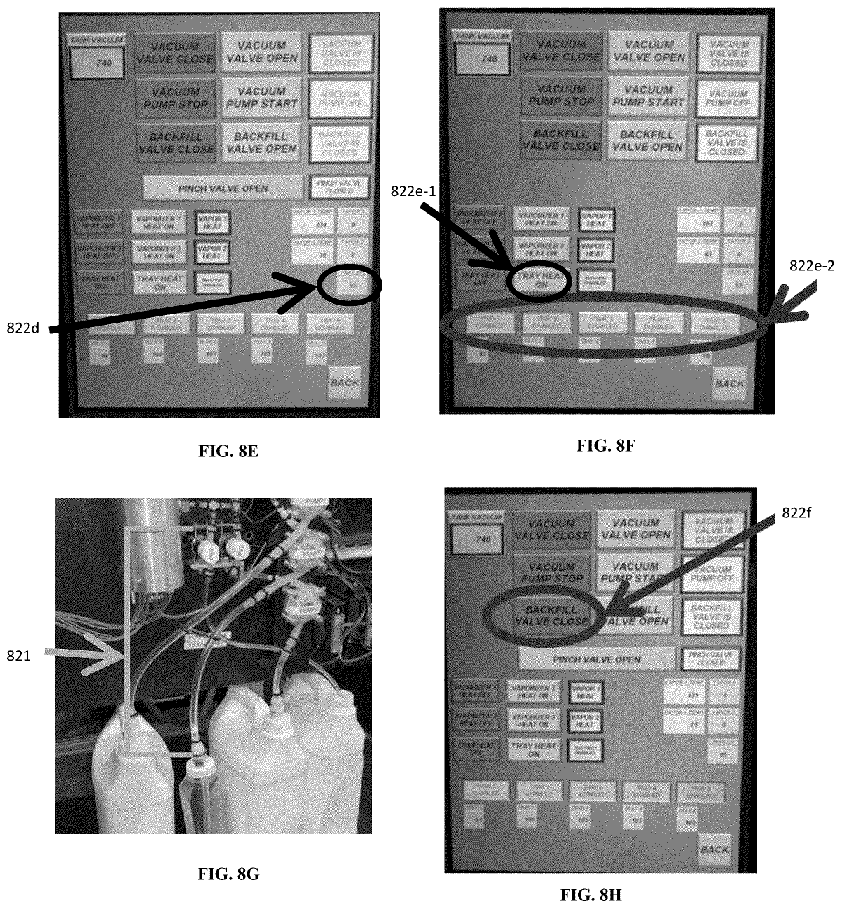

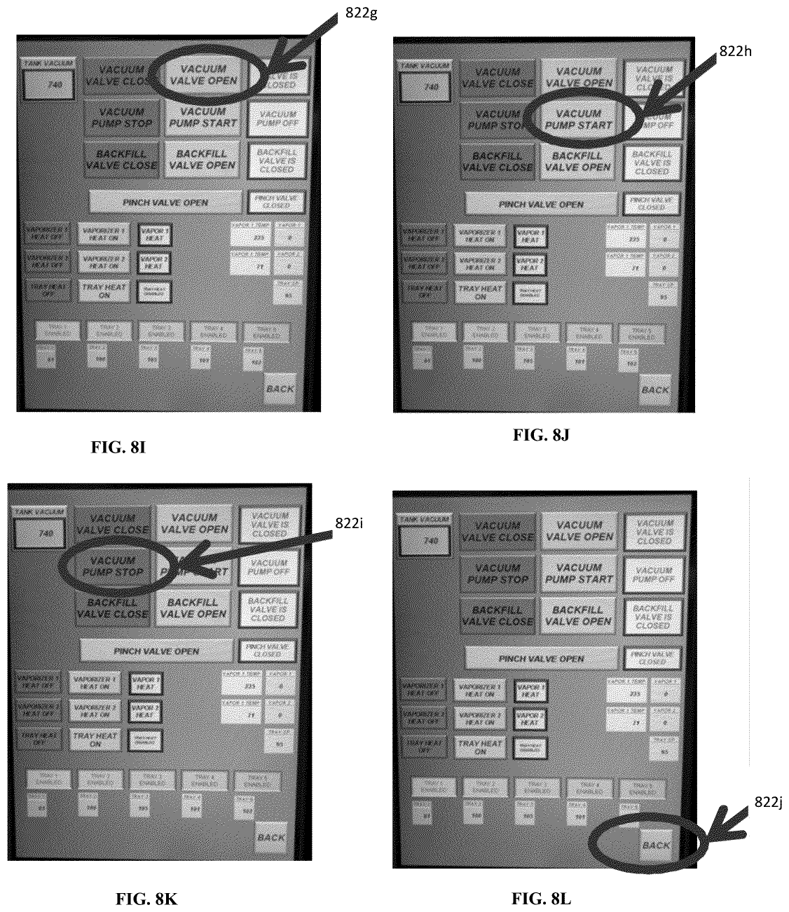

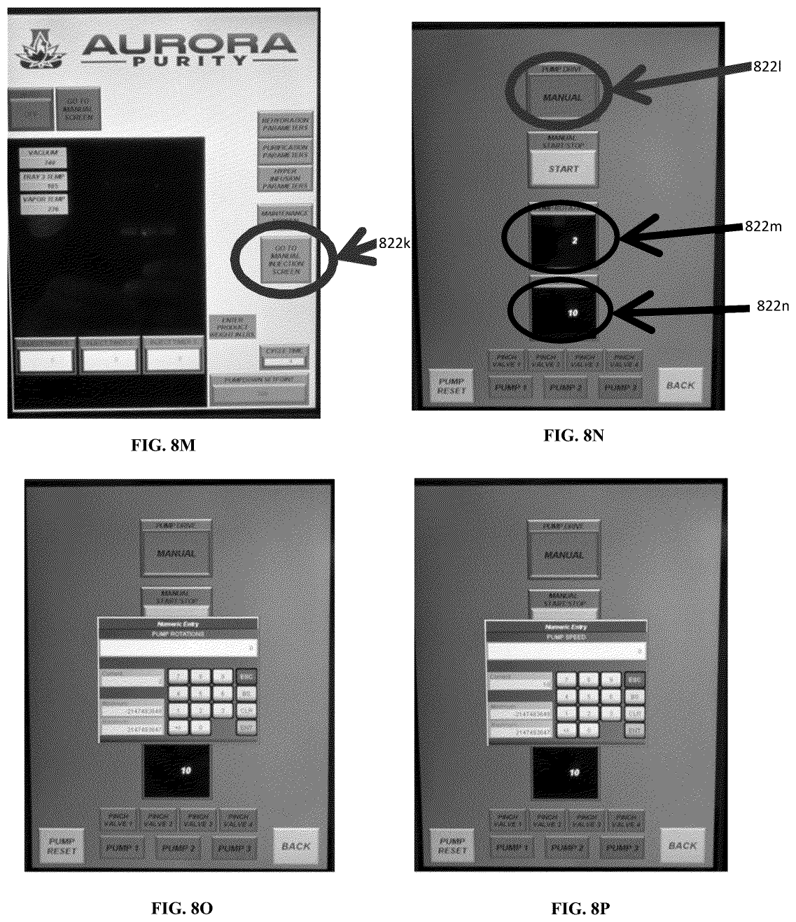

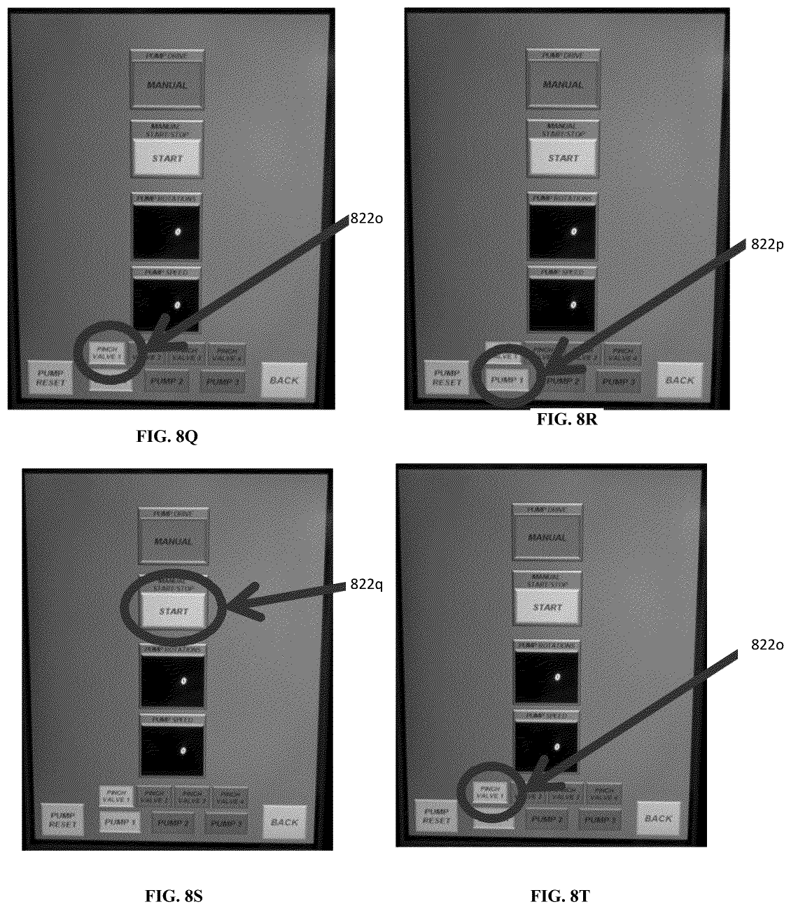

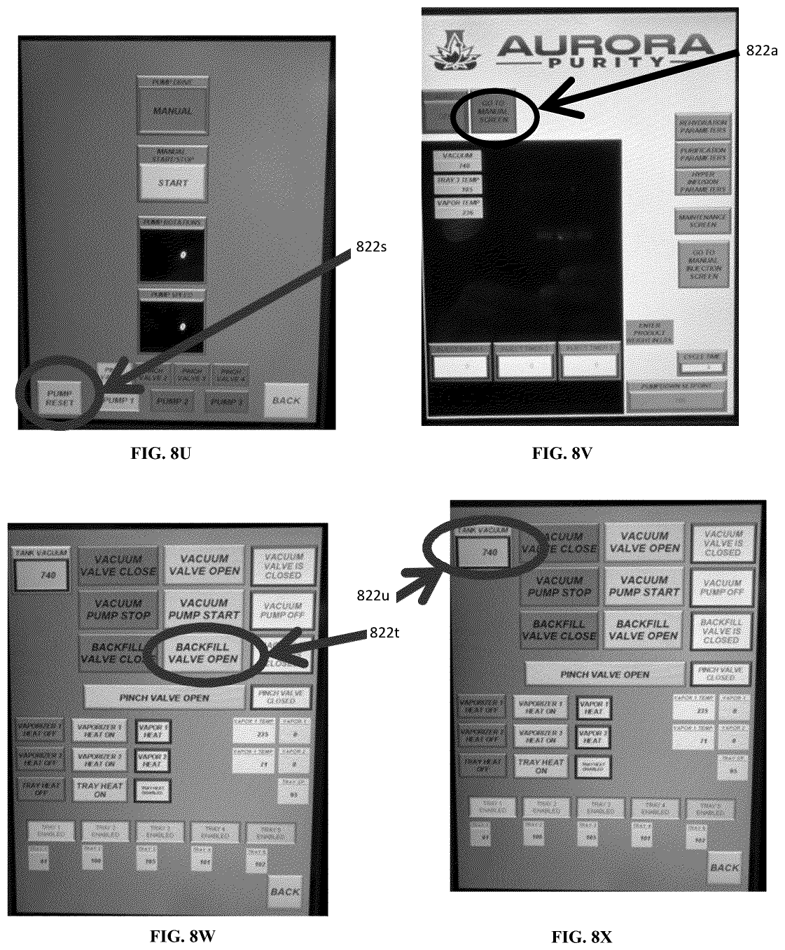

FIGS. 8A-8X illustrate the standard operating procedure for manual operation of the plant infuser, according to an aspect. Manual operations may begin with the preparation of a log for collecting data. Following log preparation, and with manual controls enabled, such as by toggling the MANUAL CONTROL button 720a seen in FIG. 7E to “manual”, the user may hit the GO TO MANUAL SCREEN button 822a of FIG. 8A to access the manual control screen of FIG. 8B. Upon reaching this manual control screen, the user may hit a VAPOR 1 TEMP button 822b of FIG. 8C and set the vaporizer temperature to a desired value, such as 240 degrees Fahrenheit, for example, and then hit the VAPORIZER 1 HEAT ON button 822c of FIG. 8D to begin heating said vaporizer.

The user may continue manual operation by pressing the TRAY SP button 822d of FIG. 8E and entering a desired tray temperature (e.g., temperature set point) when prompted, such as 99 degrees Fahrenheit. Next, the user may press the TRAY HEAT ON button 822e-1 and then press all of the TRAY TOGGLE buttons 822e-2 of FIG. 8F until all trays are green/enabled to start heating the trays. After enabling tray heating, the user may allow the plant infuser to heat up and prepare samples using the appropriate PPE. Once the plant infuser has reached operation temperature, the user may load the shelves with samples and close the chamber door, such as chamber door 102a of FIG. 1, ensuring the door handle is set to a vertical position to ensure a tight seal. The user may then visually check to see that the hoses 821 of FIG. 8G have been primed. After confirming that the hoses are primed, the user may select the BACKFILL VALVE CLOSE button 822f of FIG. 8H as needed, to set it to the closed/red state, which can also be verified by visually inspecting that a backfill red line (not shown) is perpendicular to the flow on the valve itself. After ensuring that the manual vacuum release valve, such as manual vacuum release valve 115 of FIG. 1, is closed by rotating its knob counterclockwise, a user may press the VACUUM VALVE OPEN button 822g of FIG. 8I, after which the user may be able to hear the vacuum valve open and the VACUUM VALVE OPEN button 822g may blink. Next, the user may press the VACUUM START button 822h of FIG. 8J and the vacuum pump will start, dropping the pressure within the vacuum chamber down to a target pressure, such as 5 torr. Once the vacuum chamber has reached the desired pressure, the user may press the VACUUM PUMP STOP button 822i of FIG. 8K, and press the BACK button 822j of FIG. 8L to return to the main menu.

From the main menu of FIG. 8M, the user may select the GO TO MANUAL INJECTION SCREEN button 822, and ensure the PUMP DRIVE button 822l of FIG. 8N is toggled to red/manual. The user may also press the PUMP ROTATIONS button 822m and PUMP SPEED button 822n, to set these values, accordingly, as shown in FIGS. 8O and 8P, respectively. Following the setting of the pump speed and pump rotations, the user may press the corresponding PINCH VALVE button 822o of FIG. 8Q followed by the appropriate PUMP button 822p of FIG. 8R to prepare a corresponding pinch valve and pump, such as a first pinch valve and first reagent pump. At this point, the injection cycle may be ready for manual injection and the user may set a stopwatch or timer to the desired number of minutes.

With plant infuser prepared for manual injection, the user may press the MANUAL START STOP button 822q of FIG. 8S to start the injection cycle, and select the PINCH VALVE button 822o of FIG. 8T again after injection, to prevent unnecessary vacuum loss. With the injection cycle complete, the user may start the timer and allow infusion to occur, repeating the injection cycle steps as desired. The user may prepare for each subsequent injection cycle by pressing the PUMP RESET button 822s of FIG. 8U prior to beginning a new injection cycle. Upon completion of all required injections, the user may hit a corresponding BACK button to return to the main screen of FIG. 8V, and hit the GO TO MANUAL SCREEN button 822a of FIG. 8V. From the manual control screen of FIG. 8W, the user may select the BACKFILL VALVE OPEN button 822t and then the user may open the manual vacuum release valve, such as manual vacuum release valve 115 of FIG. 1, to return the vacuum chamber to atmospheric pressure. Finally, once the TANK VACCUM indicator 822u of FIG. 8X has reached atmospheric pressure, the user may open the chamber door, retrieve the infused samples and package/prepare them, accordingly, using gloves as needed to prevent contamination.

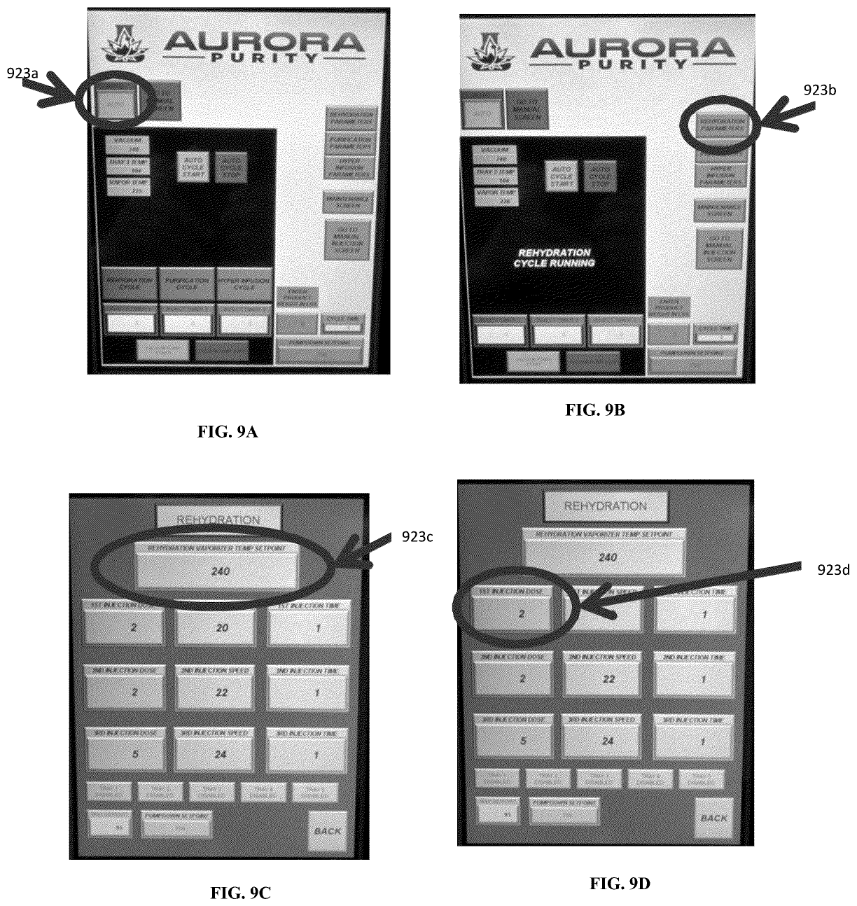

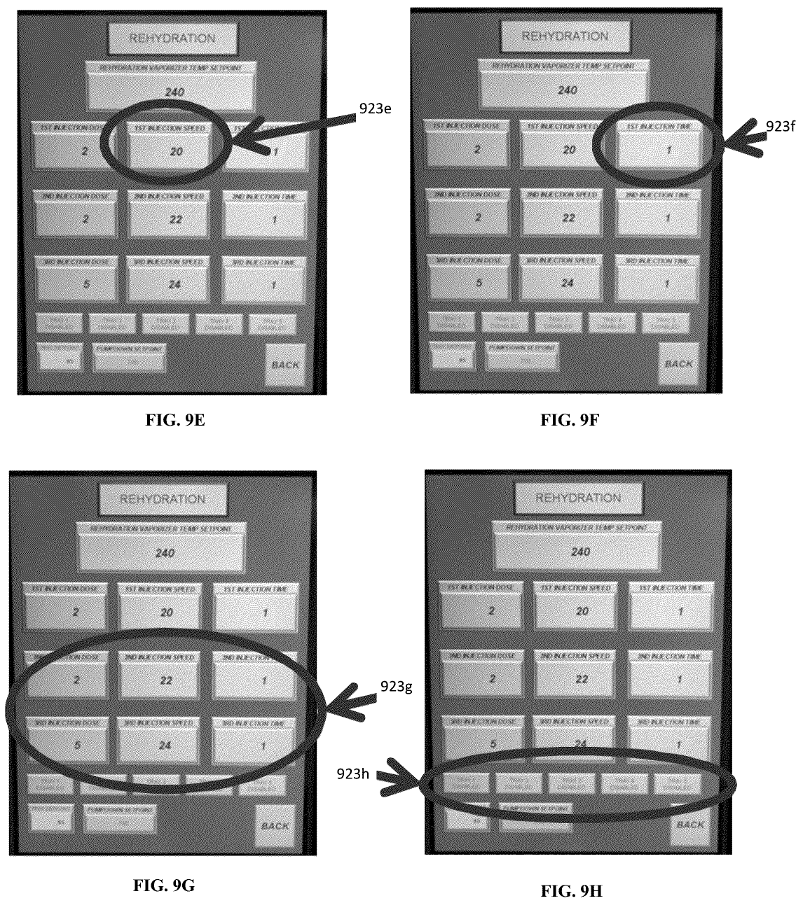

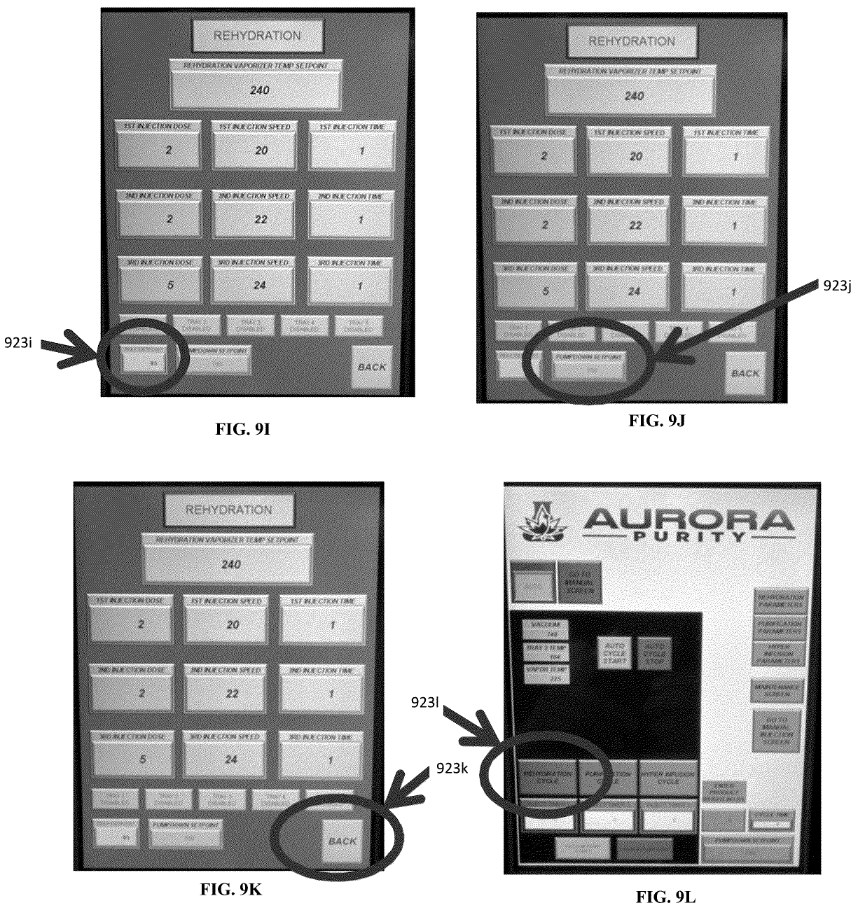

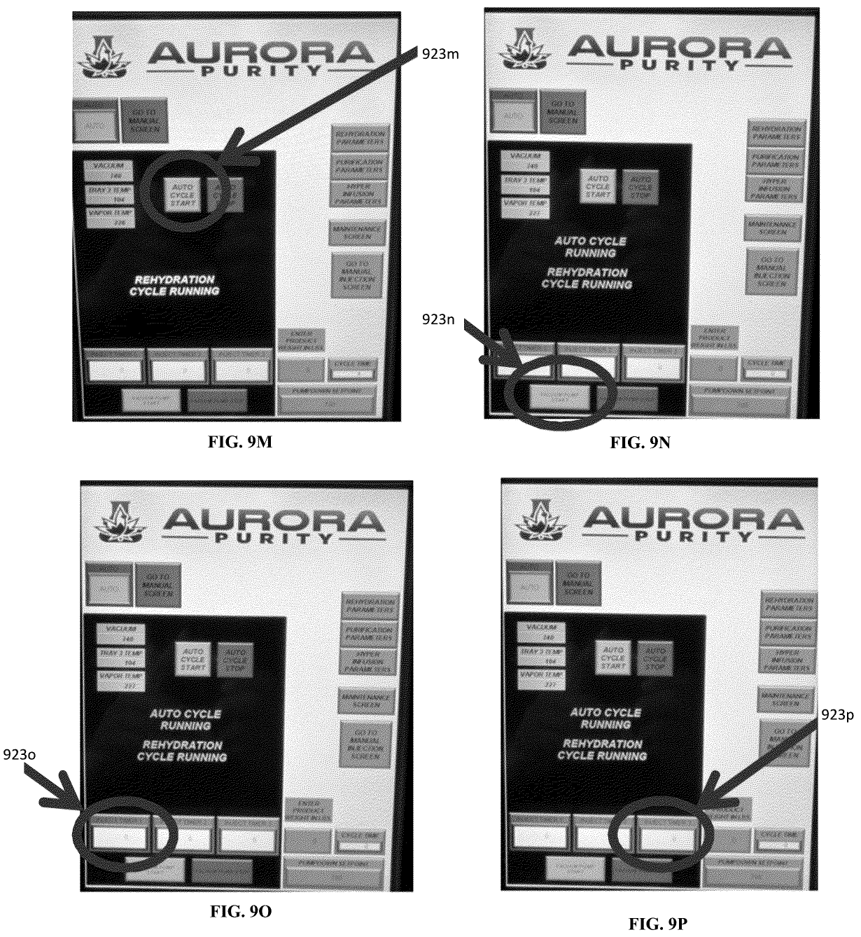

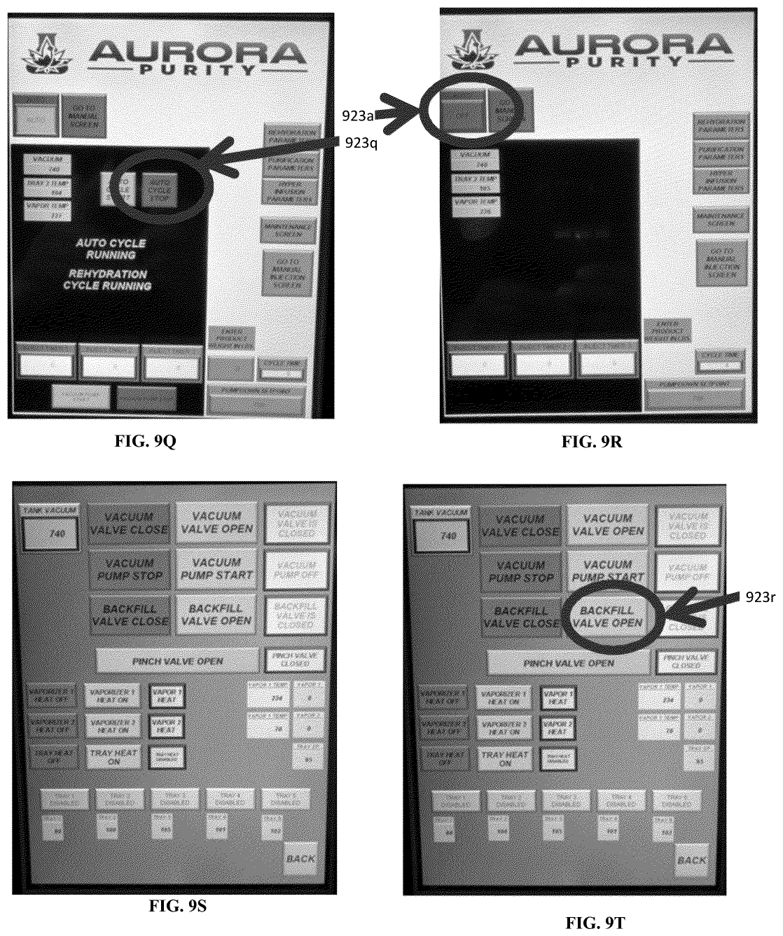

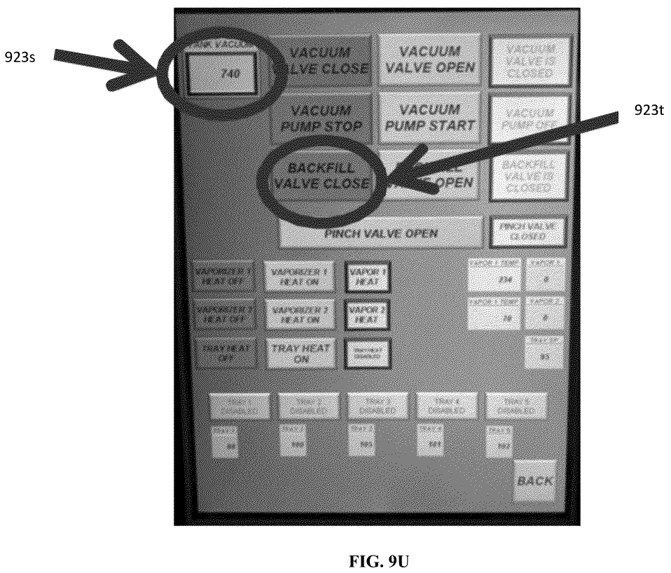

FIGS. 9A-9U Illustrate the standard operating procedure for automatic operation of the plant infuser, according to an aspect. In contrast to the manual operation procedure disclosed hereinabove in FIG. 8A-8X, the automatic operation for the plant infuser may have fewer steps that must be performed, as a result of automated process utilized hereinbelow. Starting from the main screen of FIG. 9A, the user may confirm that the MANUAL CONTROL button 923a is set to auto/green to enable automated procedures. Next, from the main screen of FIG. 9B, the user may select the desired procedure. In the present example, the REHYDRATION PARAMETER button 923b may be selected by the user to perform an automated rehydration process.

After being sent to the rehydration parameter screen of FIG. 9C from selecting the REHYDRATION PARAMETER button 923b, the user may select on the VAPORIZER TEMPERATURE button 923c and set the vaporizer to the desired temperature, such as 240 degrees Fahrenheit, for example. Next, the user may select the FIRST INJECTION DOSE button 923d of FIG. 9D to set the set the number of doses, and the FIRST INJECTION SPEED button 923e of FIG. 9E to set the speed of the first injection. The user may continue by selecting the FIRST INJECTION TIME button 923f of FIG. 9F to set the duration of the first injection in minutes. From here, the user may repeat the setting of the corresponding injection dose, injection speed and injection time for the second and third injections, as applicable, using the appropriate corresponding buttons 923g of FIG. 9G for each injection.

Following the setting of the injection setting disclosed hereinabove in FIG. 9D-9G, the user may select the TRAY TOGGLE buttons 923h of FIG. 9H to enable the heating of each tray. The set temperature for each tray may then be set by pressing the TRAY SETPOINT button 923i of FIG. 9I and entering the desired tray temperature accordingly. The user may continue by pressing the PUMP DOWN SET POINT 923j of FIG. 9J, based on the desired parameter for the particular infusion. With these automated settings entered accordingly, the user may return to the main screen by pressing the BACK button 923k of FIG. 9K.

From the main screen of FIG. 9L, the user may hit the appropriate cycle/procedure button for the parameters that were just set. In this embodiment, as a result of setting the rehydration parameters, the user will select the REHYDRATION CYCLE button 923l. With the REHYDRATION CYCLE button 923l selected and flashing, the user may select the AUTO CYCLE START button 923m of FIG. 9M to start the rehydration cycle, at which point the user may hear the vacuum valve open in the back of the plant infuser. From there, the user may select the VACUUM PUMP START button 923n of FIG. 9N to start the vacuum and the cycle process, wherein the vacuum valve automatically closes, and the vacuum pump stops upon reaching the set vacuum conditions. Upon hitting the VACUUM PUMP START button 923n, the first injection will begin and the FIRST INJECTION TIMER 923o of FIG. 9O will begin counting. The corresponding injection timers for the second and third injection will begin sequentially as each prior injection finishes (starting with the first injection, followed by the second injection, and then the third injection). After the completion of the third injection (e.g., the THIRD INJECTION TIMER 923p of FIG. 9P stops, the plant infuser may stop the rehydration procedure, wherein the final time duration will be indicative of when the rehydration cycle has stopped.

After the plant infuser has finished the rehydration cycle described hereinabove, the user may select the AUTO CYCLE STOP button 923q of FIG. 9Q and then switch the plant infuser back to manual mode by selecting the MANUAL CONTROL button 923a until said button turns red and reads “Off” to indicate manual controls have been activated, as seen in FIG. 9R and then selecting the GO TO MANUAL SCREEN button to enter the manual screen of FIG. 9S. From the manual screen, the user may select the BACK FILL VALVE OPEN button 923r of FIG. 9T to open the vacuum chamber to the environment to equalize the pressure within the plant infuser. The user may also open a manual hand valve (not shown) on the front of the plant infuser to aid in the release of the vacuum. Once the TANK VACCUM indicator 923s of FIG. 9U returns to around atmospheric pressure (e.g., about 750 torr), the user may select the BACK FILL VALVE CLOSE button 923t of FIG. 9U to re-seal the vacuum chamber after pressure equalization. Finally, the user may open the door to retrieve the samples, and package/prepare the samples accordingly.

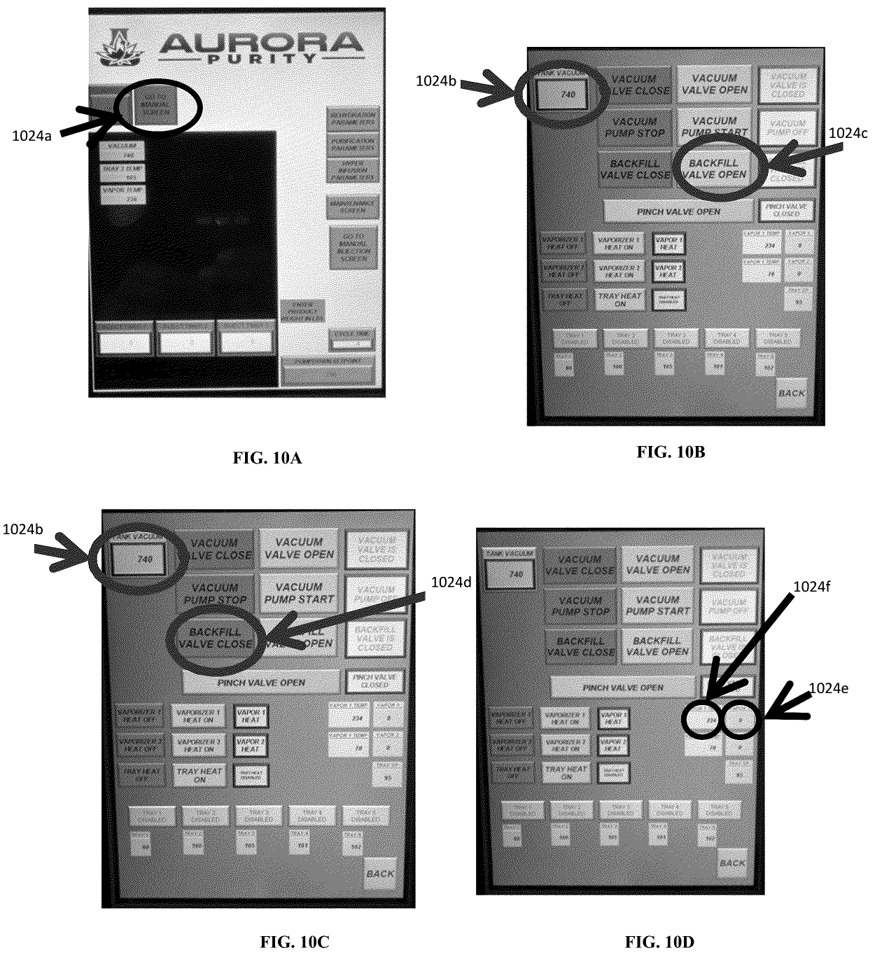

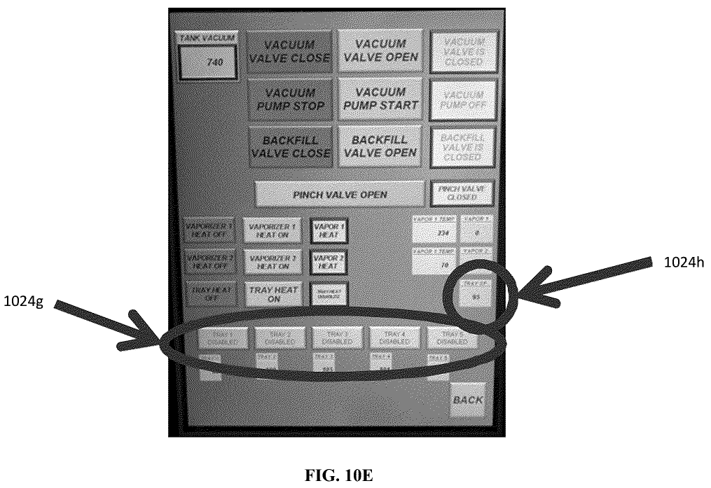

FIGS. 10A-10E illustrate the standard operating procedure for the shutting down of the plant infuser, according to an aspect. Starting from the main screen of FIG. 10A, a user may begin the procedure for shutting down the plant infuser by ensuring the main screen is in manual mode, as disclosed hereinabove, and then selecting the “GO TO MANUAL SCREEN” button 1024a, as seen in FIG. 10A. From the manual screen of FIG. 10B, the user may confirm that the TANK VACUUM indicator 1024b reads 750 torr (e.g., the vacuum chamber is at roughly atmospheric pressure), or if not, the user may select the BACK FILL VALVE OPEN button 1024c and wait until the TANK VACUUM indicator 1024b reads 750 torr. Once said TANK VACUUM INDICATOR 1024c reads 750 torr, the user may then select the BACK FILL VALVE CLOSED button 1024d of FIG. 10C to reseal the vacuum chamber.

Following the above described pressure equalization procedure, the user may select the VAPOR TEMP 1 button 1024e of FIG. 10D and set a value of 0 degrees Fahrenheit to ensure that the VAPORIZER TEMPERATURE indicator 1024f drops to ambient temperatures. The user may then stop the heating of the trays by selecting the TRAY SP button 1024h and setting the tray setpoint temperature value to 0 degrees Fahrenheit, as well as selecting each TRAY TOGGLE button 1024g until heating for all trays is disabled, as seen in FIG. 10E. Finally, the user may turn off a main power switch of the plant infuser, thus powering down the device. As is understood, each process described herein may be modified depending on the desired operating parameters, type of infusion process, types of samples and reagents used, etc. As such, additional steps that exist within the scope of this invention may be added or steps may be removed as necessary to achieve a desired result. Furthermore, the term “selecting,” and the like may be used herein in relation to manipulating each digital button to utilize the infuser control having a touch screen, but similar terms such as pressing, choosing, clicking, etc., may also be used in relation to the manipulation of buttons on the infuser controller, as applicable.

FIG. 11 illustrates a schematic diagram of an alternative embodiment of the disclosed plant infuser 1101, according to an aspect. As described above the disclosed plant infusers are configured to infuse terpenes (and/or other materials) from a terpene source(s) through the utilization of various complementary structures, such as pumps, valves, etc. Furthermore, additional structures may be added to the plant infuser embodiments of FIGS. 1-6 to improve certain aspects of device function, as will be described hereinbelow. The disclosed alternative embodiment of the plant diffuser 1101 may be same as the above described plant infuser of FIGS. 1-6, unless otherwise noted herein.

In contrast to the prior disclosed plant infuser 101 embodiment of FIG. 1, the alternative plant infuser embodiment of FIG. 11 may have a plurality of designated reagent injection syringes (“fluid injection syringes”, “reagent syringes”, “syringes”) 1125. Each reagent injection syringe 1125 may be configured to inject a corresponding reagent (e.g., terpenes, water, etc.) into the fluid line for vaporization within the following vaporizer 1106. Each reagent injection syringes 1125 may be in fluid communication with a corresponding flow control valve 1126 of a plurality of flow control valves 1126. This plurality of flow control valves 1126 may be utilized in place of the disclosed reagent pumps, such as reagent pumps 308a-308c of FIG. 3, to control the flow of terpenes from the reagent injection syringes 1125. In an embodiment, each flow control valve 1126 that is in fluid communication with an injection syringe 1125 may also be in fluid communication with a corresponding pinch valve 1107, wherein the disclosed pinch valve 1107 of FIG. 11 is similar to the prior disclosed pinch valves 307a-307d of FIG. 3.

Unlike previous embodiments of the disclosed plant infuser, the alternative plant infuser 1101 of FIG. 11 may not utilize “reagent pumps”, such as reagent pumps 308a-308c of FIG. 3, which may have been peristaltic pumps for previous embodiments. In contrast, the alternative embodiment of the plant infuser 1101 may utilize the vacuum provided by the vacuum pump 1110 to pull reagents from the reagent injection syringes 1125 into the vaporizer 1106 and subsequently into the vacuum chamber 1102. As such, it should be understood that each reagent injection syringe 1125 may be in fluid communication with the vacuum pump 1110, by virtue of the fluid communication established between each intermediary element disposed between them, as seen in FIG. 11. For example, in an embodiment, each reagent injection syringe 1125, each flow control valve 1126, each pinch valve, the vaporizer 1108, the vacuum chamber 1102 and the vacuum pump 1110 may be in fluid communication with each other, as seen in FIG. 11.

The flow rate of each reagent from the corresponding reagent injection syringe 1125 to the vaporizer 1108 may be controlled by the manipulation of the corresponding flow control valves 1126. In an embodiment, these flow control valves 1126 may be in electrical communication with the infusion controller, in order to allow a user (or automated process) to manipulate each reagent flow rate to the vaporizer (and thus to the vacuum chamber) as needed. Additionally, each pinch valve 1107 may also be in electrical communication with the flow controller, wherein each pinch valve 1107 is configured to selectively stop the flow of a corresponding reagent to the vaporizer. In an alternative embodiment, each flow control valve 1126 and pinch valve 1107 may be configured to be directly manipulated/manually manipulated by a user manually to control flow rate.

As can be seen in FIG. 11, each pinch valve 1107 may also be in fluid communication with the vaporizer 1106, such that a terpene or other material origination from one of the reagent injection syringes 1125 may be configured to travel from the injection syringe to a corresponding flow control valve 1126, then through a corresponding pinch valve 1107 before traveling to the vaporizer 1106. As is understood, the disclosed arrangement of injection syringes 1125, flow control valves 1126 and pinch valves 1107 may be configured to deliver a selected reagent or combination of reagents (in specific amounts) to the vaporizer 1106, in the desired amounts and at the desired rates, for distribution to the vacuum chamber 1102.

As is understood, the specific compositions of the piping/lines that allow fluid flow between elements may be made from an appropriate material based on the temperature, composition, pressure requirements of the fluid/vapor being carried. For example, pipes/lines configured to control the flow of higher temperature fluids and gases may be made of stainless steel, or another suitable high temperature material, to avoid damage to the pipes and lines during device function. In an embodiment, a line disposed between and in fluid/fluid communication with the vaporizer 1106 and the vacuum chamber 1102 (referred to as a vacuum chamber feed line 1131) may be made from stainless steel, to avoid being damaged by the vaporized reagents travelling from the vaporizer 1106 to the vacuum chamber 1102. As can be seen in FIG. 11, each reagent may travel through a shared vaporizer feel line 1130 after leaving their corresponding pinch valve in order to reach the vaporizer 1106. As such, reagents may be selectively mixed in the vaporizer feel line 1130 prior to reaching the vaporizer 1106.

For simplicity, each injection syringe 1125, flow control valve 1126 and pinch valve 1107 configured to carry a corresponding reagent to the vaporizer feed line 1130 may together be referred to as a “reagent supply line”. For example, a first reagent supply line configured to carry a first reagent may comprise a first injection syringe 1125a, a first flow control valve 1126a and first pinch valve 1107a. This relation may be similar for the second, third, fourth and fifth reagent supply lines seen in FIG. 11. Furthermore, each reagent supply line may be configured to feed into the vaporizer feed line 1130, such that each reagent may travel on a shared structure to the vaporizer 1106. As is understood, each reagent supply line may be in fluid communication with the vaporizer feed line 1130 to facilitate the flow of each reagent to the vaporizer 1106

In an embodiment, the disclosed alternative plant infuser may further comprise a dedicated cleaning line 1127. In said embodiment, this dedicated cleaning line 1127 may comprise a cleaning syringe 1127A having a suitable cleaning solution, and a cleaning line flow control valve 1127b in fluid communication with the cleaning syringe 1127A. The cleaning line control valve 1127b may also be in fluid communication with the vaporizer 1106, such that cleaning solution traveling from the cleaning line 1127 to the vaporizer 1127 may travel through the same length of piping/vaporizer feed line 1130 (or other structure) that the merged reagents leaving their corresponding pinch valves 1107 travel through. This in turn will help to ensure that anywhere that the reagent is touching will be suitably cleaned through the selective flow of cleaning solution from the cleaning line 1127.

Similar to the plant infuser described hereinabove, the reagents may flow from their corresponding pinch valves into the vaporizer 1106, wherein each reagent may be suitably vaporized prior to being injected or otherwise distributed into the vacuum chamber 1102. While the vaporizer 1106 of the alternative plant infuser 1101 may be fundamentally similar to the prior disclosed vaporizers, such as vaporizer 306 of FIG. 3, the make, model, operating parameters, etc., of the alternative plant infuser 1101 may be adjusted in accordance with the needs of the application.

In an embodiment, the actuation of the corresponding flow control valves 1126 pinch valve to facilitate the flow or reagents to the vaporizer may only begin after the vacuum chamber 1102 has achieved the necessary operation conditions. In an embodiment, these operating conditions within the vacuum chamber 1102 may be achieve a pressure of 1-5 torr, though this may be varied depending on reagents being used, the amount of sample being infused, the characteristics of the reagents and samples, etc. In an embodiment, in order to get the vacuum chamber 1102 down to the desired pressure, the vacuum pump may vacuum through a cold trap 1128 and then to the back of the vacuum chamber port. The cold trap 1128 is configured to reduce the amount of vapors/chemicals (e.g. unused reagents, formed chemicals, gaseous byproducts, etc.) that leave the vacuum chamber 1102 while under vacuum. This reduces the vapors expelled into the surrounding air as well as those pulled inside the vacuum pump 1110. In an embodiment, the disclosed cold trap 1128 may be in fluid communication with the vacuum chamber 1102, wherein an optional needle valve 1129 is disposed between and in fluid communication with the cold trap 1128 and the vacuum chamber 1102. In an alternative embodiment, no valves may be disposed between the cold trap 1128 and the vacuum chamber 1102, such that only a suitable length of piping is disposed between the cold trap 1128 and the vacuum chamber 1102.

Similarly to the plant infuser embodiments of FIG. 1-6, the alternative plant infuser may also be equipped with a pressure gauge 1102d disposed on the vacuum chamber 1102 to provide an external indication of current chamber cavity pressure and a vacuum release/vent valve 1115 configured to allow air to be drawn into the vacuum chamber 1102 after the infusion process is complete, so that the corresponding chamber door may be opened. Again, while many aspects of the vacuum chamber may be common between the vacuum chamber embodiments, certain aspects of the alternative vacuum chamber 1102 may differ somewhat from those of the vacuum chamber 102 of FIG. 1. In an embodiment, the vacuum chamber 1102, as well as the complementary base (not shown) attached to the vacuum chamber 1102 together may be 71 inches tall, 32 inches wide and 50 inches deep, thus providing a significantly deeper vacuum chamber 1102 than the previously described vacuum chamber 102 of FIG. 1. This may allow more samples to be infused simultaneously, which may help a user infuse more materials at a time. In an embodiment, specific models of the disclosed plant infuser 1101 may be suitably sized and configured to infuse 6 lbs, 12 lbs or 24 lbs of sample in one batch/run. It should be understood that the size and general dimensions of the vacuum chamber 1102 may be adjusted in accordance with the needs of the user/application, and thus are not limited to the specific embodiments described above.

While the above disclosed embodiments of the plant infuser may often be described as infusing samples with water or terpenes to rehydrate and enhance the smell/taste of the samples, respectively, it should also be understood that different materials may also be infused into the samples to achieve a plurality of other functions. For example, if it is necessary to cleanse pathogens from a sample, the sample reagent infused into the sample may be hydrogen peroxide (H₂O₂), which may successfully destroy any pathogens which have entered the vacuum chamber. Additionally, alcohols may be used as a reagent and infused into a sample accordingly to influence the smell and taste of said sample. Again, this infusion process may use a variety of different reagents and be performed on a variety of different sample materials, including plants matter, such as flowers, and manufactured items, such as cigars, cigarettes and other paper and tobacco products.

While the plant infuser embodiments of FIGS. 1-6 and the plant infuser 1101 of FIG. 11 may differ somewhat structurally, as disclosed hereinabove, the elements may be characterized and such that similarly named structures may be present in both embodiments. For example, in the plant infuser 1101 of FIG. 11, the combination of the elements configured to control the distribution of reagents to the vaporizer 1106 may be referred to as a reagent dispenser, the reagent dispenser comprising a reagent injection syringe 1125 configured to hold a reagent, a flow control valve 1126 in fluid communication with the reagent injection syringe 1125, and a pinch valve 1107 in fluid communication with the flow control valve 1126. As seen in FIG. 11, the reagent dispenser may comprise a plurality of reagent injection syringes 1125, a plurality of flow control valves 1126 and a plurality of pinch valves 1107, wherein each fluid injection 1125 syringe of the plurality of reagent injection syringes in in fluid communication with a corresponding flow control valve 1126 of the plurality of flow control valves 1126, and each flow control valve 1126 of the plurality of flow control valves 1126 is in fluid communication with a corresponding pinch valve 1107 of the plurality of pinch valves 1107.

Similarly to the plant infusers of previous embodiments (e.g., plant infuser 101 of FIG. 1), an infuser controller, such as infuser controller 104 of FIG. 1, may also be utilized to control the elements of the plant infuser 1101 of FIG. 11. For example, the plant infuser 1101 of FIG. 11 may further comprise an infuser controller (not shown) in electrical communication with the injection syringes 1125, the flow control valve 1126 and/or the pinch valve 1107 in order to allow a user to control which reagents are distributed into the vaporizer 1106 and subsequently dispensed into the vacuum chamber 1102. In an embodiment, the plurality of injection syringes 1125, flow control valves 1126 and pinch valves 1107 may be considered elements of a corresponding base, similar to base 103 of FIG. 1, such that the infuser controller is in electrical communication with the base, such that a user may manipulate the infuser controller to control the flow of reagents from the reagent dispenser to the vaporizer.

FIG. 12 illustrates a front perspective view of an alternative embodiment of the disclosed plant infuser 1201, according to an aspect. As can be seen in FIG. 12, the disclosed alternative embodiment of the plant infuser 1201 may have a similar configuration to the prior disclosed plant infuser 101 embodiment of FIG. 1. This alternative embodiment of the plant infuser may have a vacuum chamber 1202 with a chamber door 1202a pivotally engaged with a chamber body 1202b, to selectively seal a corresponding chamber cavity. Also, this vacuum chamber may be disposed above a base 1203. Furthermore, in an embodiment, the vacuum pump 1210 may be stored within the base 1203.

In contrast to the previously disclosed plant infuser embodiment 101 of FIG. 1, the positioning of the reagents may be somewhat elevated. As can be seen in FIG. 12, an injection syringe receptacle 1240 may be disposed above the base 1203 and next to the vacuum chamber 1202. This positioning of the syringe receptacle 1240 may allow a user to access reagents and their corresponding syringes with ease. The syringe receptacle 1240 will be discussed in greater detail hereinbelow.

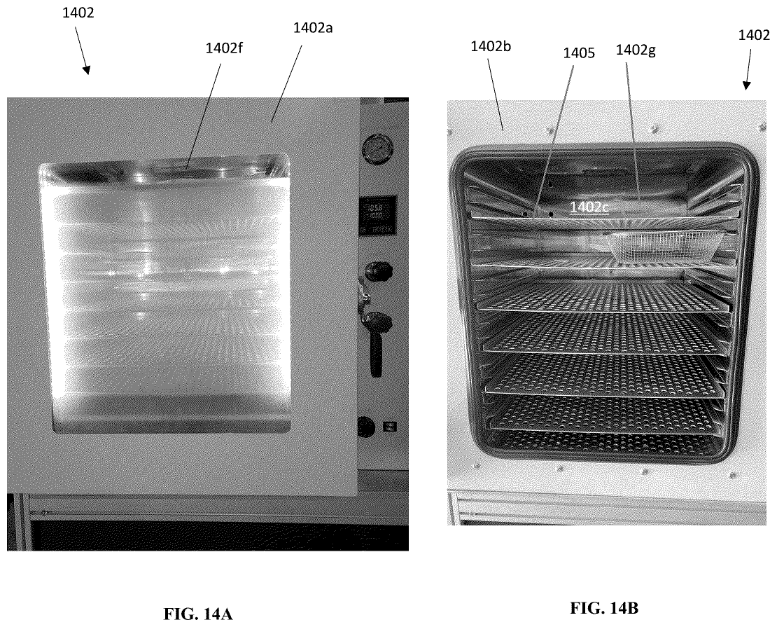

FIG. 13A-13B illustrate the side perspective views of a syringe receptacle 1340, according to an aspect. As is understood, the syringe receptacle 1340 is configured to contain the injection syringes 1325 containing the reagents to be infused into the samples within the vacuum chamber. While the disclosed embodiment of the syringe receptacle 1340 may be shown containing a first reagent injection syringe 1325a in fluid communication with a first flow control valve 1326a, a second reagent injection syringe 1325b in fluid communication with a second flow control valve 1326b, a third reagent injection syringe 1325c in fluid communication with a third flow control valve 1326a and a fourth reagent injection syringe 1325d with a fourth flow control valve 1326d, it should be understood that the syringe receptacle 1340 may be adapted to contain as many reagent injection syringes 1325 (and flow control valves) as is necessary to achieve the intended infusion process. Additionally, the syringe receptacle 1340 may further comprise an air burst valve (“air burst”) configured to selectively allow air to flow in the plant infuser, as necessary. In an embodiment, the air burst valve may be in electrical communication with infuser controller, such that the air burst valve may be electrically actuated as needed. While not visible in FIG. 13, each pinch valve shown in FIG. 11 may be in fluid communication with a corresponding flow control valve 1326a-1326d.

FIG. 14A-14B illustrate the front perspective views of a vacuum chamber 1402 with the chamber door 1402a closed and a vacuum chamber 1402 with the chamber 1402a door open, respectively, according to an aspect. Again, the vacuum chamber 1402 may be configured to be selectively sealed by closing the chamber 1402a to form a chamber cavity 1402c. The pivotal engagement of the chamber door 1402a with the chamber body 1402b may allow the chamber cavity to be sealed in accordance with the needs of the user.

As disclosed hereinabove, the chamber door 1402a may have a glass portion 1402f that allows a user to visually inspect samples during infusion, which may be helpful for observing progress, detecting potential issues, etc. Furthermore, in order to provide a suitable amount of heating to the held samples, the vacuum chamber 1402 may have at least one heated wall 1402g in thermal communication with the vacuum cavity 1402c, wherein the heated wall is configured to selectively provide heat to the samples within the vacuum cavity 1402c during infusion. The heating provided by each heated wall 1402g may be configured to be controlled manually, automatically by the infusion controller, or with a combination of manual and automatic controls. It should be understood that each heating element utilized to heat samples within the vacuum chamber 1402, such as the heated wall 1402g, or a heated roof, heated floor, heated door etc., may simply be referred to as a “heater”. As with previous vacuum chamber embodiments, a plurality of shelves 1405 may be disposed within the vacuum chamber 1402 to provide additional surface area to place samples for infusion.

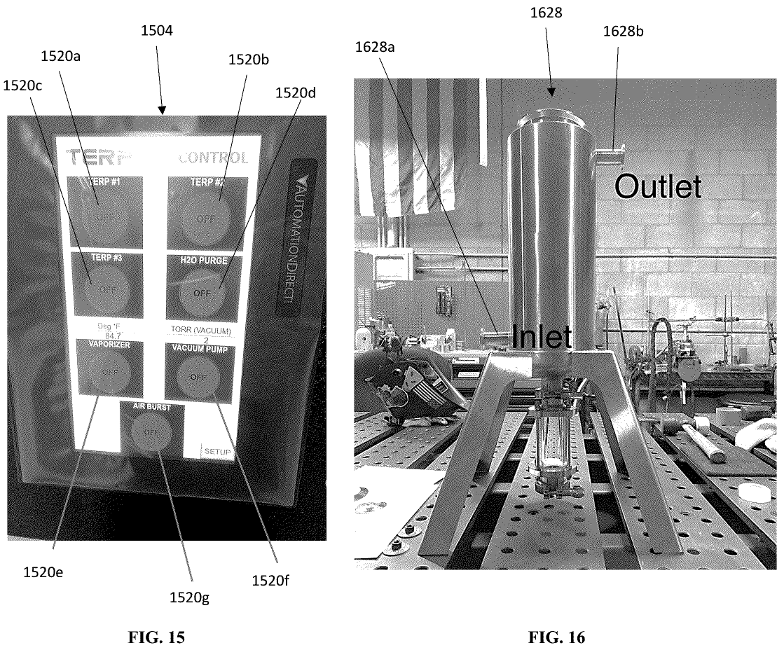

FIG. 15 illustrates the front perspective view of an infuser controller 104, according to an aspect. As with previous infuser controller embodiments, the disclosed infuser controller 104 of FIG. 15 may have a plurality of control buttons 1520a-1520g. In said embodiment, the infuser controller may comprise a first reagent control button 1520a, a second reagent control button 1520b, a third reagent control button 1520c, a water purge button 1520d, a vaporizer control button 1520e, a vacuum pump control button 1520f and an air burst button 1520g. It should be understood that each control button 1520a-1520g may be configured to facilitate manipulation of a corresponding element in accordance with the present disclosure, wherein control buttons such as the vaporizer control button 1520e and the vacuum control button 1520f may also have adjustable controls for their corresponding temperature and provided pressure, respectively. Furthermore, the air burst button 1520g may be configured to selectively actuate the air burst valve, such as air burst valve 1350 of FIG. 13, to pull air from the external environment into the plant infuser, as needed.

FIG. 16 illustrates the front perspective view of a cold trap 1628, according to an aspect. As disclosed hereinabove, the cold trap 1628 may be configured to reduce the amount of vapors/chemicals that leave the vacuum chamber while under vacuum. In an embodiment, the cold trap 1628 may be disposed between and in fluid communication with the vacuum chamber and the vacuum pump, wherein a cold trap inlet 1628a is engaged with the vacuum chamber and the cold trap outlet is engaged with the vacuum pump. In an embodiment, a vacuum chamber exhaust stream may leave the vacuum chamber heading toward the vacuum pump, wherein the vacuum chamber exhaust stream contains both reagent/chemical vapors and dry air. Upon leaving the vacuum chamber, the vacuum chamber exhaust stream may travel into the cold trap 1628 through the cold trap inlet 1628a, wherein the reagent/chemical vapors become trapped in the cold trap 1628, and the dry air leaves the cold trap 1628 through the cold trap outlet 1628 and flows into the vacuum pump.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. As used in this application, “and/or” means that the listed items are alternatives, but the alternatives also include any combination of the listed items.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. The terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases.

Throughout this description, the aspects, embodiments or examples shown should be considered as exemplars, rather than limitations on the apparatus or procedures disclosed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples.

What is claimed is:

1. An infusion apparatus configured to infuse reagents into plant samples, the infusion apparatus comprising:
a reagent dispenser having a plurality of reagents, the reagent dispenser having:
at least one reagent supply line, each reagent supply line having:
a reagent injection syringe configured to hold a corresponding reagent of the plurality of reagents;
a flow control valve in fluid communication with the reagent injection syringe; and
a pinch valve in fluid communication with the flow control valve;
a vaporizer feed line in fluid communication with each reagent supply line of the at least one reagent supply line;
a vaporizer in fluid communication with vaporizer feed line;
a vacuum chamber feed line in fluid communication with the vaporizer;
a vacuum chamber in fluid communication with the vacuum chamber feed line;
a vacuum pump in fluid communication with the vacuum chamber; and
an infuser controller in electrical communication with the reagent dispenser, the vaporizer, the vacuum chamber and the vacuum pump;
wherein flow of each reagent of the plurality of reagents from the reagent dispenser through the vaporizer feed line into the vaporizer and then through the vacuum chamber feed line into the vacuum chamber is controlled by the infuser controller, such that each reagent of the plurality of reagents is configured to be selectively infused into at least one plant sample disposed within the vacuum chamber.

2. The infusion apparatus of claim 1, wherein the vacuum chamber feed line is made from stainless steel.

3. The infusion apparatus of claim 1, further comprising a cold trap disposed between and in fluid communication with the vacuum chamber and the vacuum pump, wherein the cold trap is configured to condense gaseous reagents flowing out of the vacuum chamber toward the vacuum pump.

4. The vacuum chamber of claim 1, comprising:
a chamber body having a chamber cavity;
a chamber door pivotally engaged with the chamber body, wherein the chamber door is configured to be selectively rotated to seal the chamber cavity;
a plurality of shelves disposed within the chamber cavity and engaged with the chamber body, wherein the plurality of shelves is configured to hold the at least one plant sample.

5. The vacuum chamber of claim 4, further comprising a heated wall in thermal communication with the chamber cavity, wherein the heated wall is configured to heat the at least one plant sample disposed within the vacuum chamber.

6. An infusion apparatus configured to infuse reagents into a sample, the infusion apparatus comprising:
a reagent dispenser having at least one reagent:
a vaporizer in fluid communication with the reagent dispenser;
a vacuum chamber in fluid communication with the vaporizer;
a vacuum pump in fluid communication with the vacuum chamber; and
an infuser controller in electrical communication with the reagent dispenser, the vaporizer, the vacuum chamber and the vacuum pump;
wherein flow of each reagent of the at least one reagent from the reagent dispenser through the vaporizer and into the vacuum chamber is controlled by the infuser controller, such that the at least one reagent is configured to be selectively infused into at least one sample stored within the vacuum chamber.

7. The infusion apparatus of claim 6, the reagent dispenser comprising at least one reagent supply line, each reagent supply line having:
a reagent injection syringe configured to hold a corresponding reagent of the at least one reagent;
a flow control valve in fluid communication with the reagent injection syringe; and
a pinch valve in fluid communication with the flow control valve;
wherein the pinch valve is in fluid communication with the vaporizer.

8. The reagent dispenser of claim 7, comprising a plurality of reagent supply lines, wherein each reagent supply line of the plurality of reagent supply lines is configured to feed from a corresponding pinch valve into a vaporizer feed line before flowing into the vaporizer.

9. The infusion apparatus of claim 6, wherein each reagent held in the reagent dispenser is a liquid, and the vaporizer is configured to vaporize each reagent before each reagent flows into the vacuum chamber.

10. The reagent dispenser of claim 6, comprising:
a reagent container configured to hold the at least one reagent;
a reagent pump in fluid communication with the reagent container; and
a pinch valve in fluid communication with the reagent pump;
wherein the pinch valve is in fluid communication with the vaporizer.

11. The infusion apparatus of claim 6, further comprising a cold trap disposed between and in fluid communication with the vacuum chamber and the vacuum pump, wherein the cold trap is configured to condense gaseous reagents flowing out of the vacuum chamber toward the vacuum pump.

12. The infusion apparatus of claim 6, wherein the vacuum chamber comprises a plurality of heaters in thermal communication with a vacuum cavity of the vacuum chamber, the plurality of heaters being configured to heat samples disposed within the vacuum chamber.

13. The vacuum chamber of claim 6, comprising:
a chamber body having a chamber cavity;
a chamber door pivotally engaged with the chamber body, wherein the chamber door is configured to be selectively rotated to seal the chamber cavity;
a plurality of shelves disposed within the chamber cavity and engaged with the chamber body, wherein the plurality of shelves is configured to hold the at least one sample.

14. The vacuum chamber of claim 13, further comprising a main reagent line in fluid communication with the vaporizer and a plurality of distribution arms in fluid communication with the main reagent line, such that each reagent flows from the vaporizer through the main reagent line, and then through the plurality of distribution arms before being injected into the vacuum cavity, wherein each distribution arm is disposed above a corresponding shelf of the plurality of shelves, such each reagent flowing through each distribution arm is configured to be infused into each sample disposed on the corresponding shelf.

15. The infusion apparatus of claim 8, further comprising a cleaning line in fluid communication with the vaporizer feed line, such that a cleaning solution introduced from the cleaning line is configured to flow through the vaporizer feed line.

16. The infusion apparatus of claim 6, further comprising a vacuum chamber feed line disposed between and in fluid communication with the vacuum chamber and the vaporizer, wherein the vacuum chamber feed line is made from stainless steel.

17. A method of infusing a reagent into a sample within an infusion apparatus, the infusion apparatus having a reagent dispenser having the reagent, a vaporizer in fluid communication with the reagent dispenser, a vacuum chamber in fluid communication with the vaporizer; a vacuum pump in fluid communication with the vacuum chamber; and an infuser controller in electrical communication with the reagent dispenser, the vaporizer, the vacuum chamber and the vacuum pump, the method of infusing the reagent into the sample within the infusion apparatus comprising the steps of:
introducing the sample into the vacuum chamber;
sealing the vacuum chamber;
interacting with the infuser controller to actuate the vacuum pump, such that actuation of the vacuum pump produces a vacuum within the vacuum chamber;
interacting with the infuser controller to actuate a heated wall within the vacuum chamber;
interacting with the infuser controller to initiate flow of the reagent from the reagent dispenser, through the vaporizer, and into the vacuum chamber; and
allowing the reagent to be infused into the sample disposed within the vacuum chamber.

18. The method of claim 17, further comprising allowing the infuser controller to automatically disengage the vacuum pump after the reagent has been infused into the sample.

19. The method of claim 17, the reagent dispenser comprising: a reagent injection syringe configured to hold a corresponding reagent; a flow control valve in fluid communication with the reagent injection syringe; and a pinch valve in fluid communication with the flow control valve; wherein interacting with the infuser controller to initiate flow of the reagent from the reagent dispenser comprises the steps of: allowing the infuser controller to actuate the flow control valve to allow the corresponding reagent to flow from the reagent dispenser to the vacuum chamber.

20. The method of claim 17, further comprising allowing the infuser controller to automatically initiate flow of additional reagents from the reagent dispenser through the vaporizer and into the vacuum chamber, wherein each reagent is injected into the vacuum chamber sequentially.
